(19) United States
(12) Patent Application Publication
(10) Pub. No.: US 2026/0197213 A1
(43) Pub. Date: Jul. 9, 2026

(54) CHANNEL STATE INFORMATION REPORTING FOR TRANSMISSIONS VIA FREQUENCY SHIFT KEYING (FSK) MODULATED FREQUENCY MODULATED CONTINUOUS WAVEFORMS (FMCW)

(71) Applicant: QUALCOMM Incorporated, San Diego, CA (US)

(72) Inventors: Min HUANG, Beijing (CN); Jing DAI, Beijing (CN); Kangqi LIU, San Diego, CA (US); Mingxi YIN, Beijing (CN); Chao WEI, Beijing (CN); Hao XU, Beijing (CN)

(21) Appl. No.: 19/134,591

(22) PCT Filed: Jan. 26, 2023
(86) PCT No.: PCT/CN2023/073472

§ 371 Date: May 30, 2025

(51) Int. Cl. H04L 27/10

(52) U.S. Cl. CPC H04L 27/10

(57) ABSTRACT

Methods, systems, and devices for wireless communication are described. Some wireless communication systems may support channel state information (CSI) reporting for frequency shift keying (FSK)-modulated frequency modulated continuous waveforms (FMCW). A first network node may receive a first set of parameters for generation of a CSI report associated with an FMCW communication type. The first network node may generate, in accordance with the first set of parameters, the CSI report based on measurement information corresponding to an FMCW-based reference signal. The CSI report may indicate a second set of parameters for FSK-modulated FMCW communications between the first network node and a second network node. The first network node may transmit the CSI report to the second network node in advance of the FSK-modulated FMCW communications between the first and second network nodes.

### CROSS REFERENCE

The present Application is a 371 national phase filing of International PCT Application No. PCT/CN2023/073472 by HUANG et al., entitled “CHANNEL STATE INFORMATION REPORTING FOR TRANSMISSIONS VIA FREQUENCY SHIFT KEYING (FSK) MODULATED FREQUENCY MODULATED CONTINUOUS WAVEFORMS (FMCW),” filed Jan. 26, 2023, which is assigned to the assignee hereof, and which is expressly incorporated by reference in its entirety herein.

### INTRODUCTION

The following relates to wireless communications related to frequency shift keying (FSK) modulation applied to frequency modulated continuous waveforms (FMCW). Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel state information (CSI) reporting for transmissions via frequency shift keying (FSK)-modulated frequency modulated continuous waveforms (FMCW). As described herein, a first network node and a second network node may exchange signaling to indicate parameters for FSK-modulated FMCW communications and may exchange CSI based on the FSK-modulated FMCW communications in accordance with the parameters. The first network node may receive, from the second network node, a first set of parameters for generation of a CSI report associated with an FMCW communication type. The first network node may generate, in accordance with the first set of parameters, the CSI report based on measurement information (e.g., a signal-to-noise ratio (SNR), an estimated channel delay, or some other measurement information) corresponding to an FMCW-based reference signal. The CSI report may indicate a second set of parameters for FSK-modulated FMCW communications between the first network node and the second network node. The second set of parameters may include one or more of a quantity of frequency shifting periods, a frequency shifting interval (e.g., a quantity of bits per frequency shifting period), and a code rate. The first network node may transmit the CSI report to the second network node in advance of the FSK-modulated FMCW communications between the first and second network nodes.

A method for wireless communication at a first network node is described. The method may include receiving first information that indicates a first set of parameters for generation of a CSI report associated with an FMCW communication type, generating, based on the first set of parameters and based on measurement information corresponding to an FMCW-based reference signal, the CSI report, the CSI report including a second set of parameters for FSK-modulated FMCW communications between the first network node and a second network node, and transmitting, before the FSK-modulated FMCW communications between the first network node and the second network node, the CSI report to the second network node.

An apparatus for wireless communication at a first network node is described. The apparatus may include a communication interface and at least one processor coupled to the communication interface. The at least one processor may be configured to receive, via the communication interface, first information that indicates a first set of parameters for generation of a CSI report associated with an FMCW communication type, generate, based on the first set of parameters and based on measurement information corresponding to an FMCW-based reference signal, the CSI report, the CSI report including a second set of parameters for FSK-modulated FMCW communications between the first network node and a second network node, and cause, before the FSK-modulated FMCW communications between the first network node and the second network node, transmission of the CSI report to the second network node.

Another apparatus for wireless communication at a first network node is described. The apparatus may include means for receiving first information that indicates a first set of parameters for generation of a CSI report associated with an FMCW communication type, means for generating, based on the first set of parameters and based on measurement information corresponding to an FMCW-based reference signal, the CSI report, the CSI report including a second set of parameters for FSK-modulated FMCW communications between the first network node and a second network node, and means for transmitting, before the FSK-modulated FMCW communications between the first network node and the second network node, the CSI report to the second network node.

A non-transitory computer-readable medium storing code for wireless communication at a first network node is described. The code may include instructions executable by a processor to receive first information that indicates a first set of parameters for generation of a CSI report associated with an FMCW communication type, generate, based on the first set of parameters and based on measurement information corresponding to an FMCW-based reference signal, the CSI report, the CSI report including a second set of parameters for FSK-modulated FMCW communications between the first network node and a second network node, and transmit, before the FSK-modulated FMCW communications between the first network node and the second network node, the CSI report to the second network node.

Some examples of the method, apparatuses, and non-transitory computer-readable medium described herein may further include operations, features, means, or instructions for communicating data with the second network node via the FSK-modulated FMCW communications based on the second set of parameters.

Some examples of the method, apparatuses, and non-transitory computer-readable medium described herein may further include operations, features, means, or instructions for receiving second information that indicates a third set of parameters for the FSK-modulated FMCW communications between the first network node and the second network node, the third set of parameters being based on the second set of parameters and communicating data with the second network node via the FSK-modulated FMCW communications based on the third set of parameters.

In some examples of the method, apparatuses, and non-transitory computer-readable medium described herein, receiving the second information may include operations, features, means, or instructions for receiving an FSK-modulated FMCW signal, where the second information may be FSK-modulated with the FSK-modulated FMCW signal.

In some examples of the method, apparatuses, and non-transitory computer-readable medium described herein, receiving the second information may include operations, features, means, or instructions for receiving a control message including the second information.

Some examples of the method, apparatuses, and non-transitory computer-readable medium described herein may further include operations, features, means, or instructions for transmitting a second FMCW-based reference signal, where the third set of parameters may be further based on measurement information corresponding to the second FMCW-based reference signal.

In some examples of the method, apparatuses, and non-transitory computer-readable medium described herein, receiving the first information may include operations, features, means, or instructions for receiving a CSI report configuration including the first information that indicates the first set of parameters, where the method further may include operations, features, means, or instructions for receiving the FMCW-based reference signal in accordance with a subset of FMCW parameters that may be included in the first set of parameters indicated via the CSI report configuration.

In some examples of the method, apparatuses, and non-transitory computer-readable medium described herein, receiving the first information may include operations, features, means, or instructions for receiving the FMCW-based reference signal including the first information, where the first information may be FSK modulated with the FMCW-based reference signal, and where the FMCW-based reference signal may be received in accordance with an initial set of parameters configured for FSK-modulated FMCW reference signals based on the first information being FSK-modulated with the FMCW-based reference signal.

In some examples of the method, apparatuses, and non-transitory computer-readable medium described herein, generating the CSI report may include operations, features, means, or instructions for determining an SNR associated with the FMCW-based reference signal, where the measurement information includes the SNR and determining, based on the SNR and from among a set of candidate quantities indicated via the first set of parameters, a quantity of frequency shifting periods for the FSK-modulated FMCW communications, where the second set of parameters for the FSK-modulated FMCW communications includes the quantity of frequency shifting periods.

In some examples of the method, apparatuses, and non-transitory computer-readable medium described herein, each frequency shifting period of the quantity of frequency shifting periods corresponds to a respective period over which a respective subset of the FSK-modulated FMCW communications may be modulated using a respective frequency shifting value of a set of candidate frequency shifting values and determining the quantity of frequency shifting periods includes determining the quantity of frequency shifting periods based on a quantity of candidate frequency shifting values in the set of candidate frequency shifting values.

In some examples of the method, apparatuses, and non-transitory computer-readable medium described herein, generating the CSI report may include operations, features, means, or instructions for estimating a maximum path delay based on the FMCW-based reference signal, where the measurement information includes the maximum path delay and determining, based on the estimated maximum path delay and from among a set of candidate frequency shifting intervals indicated via the first set of parameters, a frequency shifting interval, where the frequency shifting interval indicates a quantity of bits transmitted per frequency shifting period of the FSK-modulated FMCW communications, and where the second set of parameters includes the frequency shifting interval.

In some examples of the method, apparatuses, and non-transitory computer-readable medium described herein, generating the CSI report may include operations, features, means, or instructions for determining an SNR associated with the FMCW-based reference signal, where the measurement information includes the SNR and determining, based on second information and from among a set of candidate code rates indicated via the first set of parameters, a code rate, where the second information includes the SNR, a quantity of frequency shifting periods, and a frequency shifting interval, where the second set of parameters include the quantity of frequency shifting periods, the frequency shifting interval, and the code rate.

In some examples of the method, apparatuses, and non-transitory computer-readable medium described herein, transmitting the CSI report may include operations, features, means, or instructions for transmitting an FSK-modulated FMCW-based reference signal, where the CSI report may be FSK-modulated with the FSK-modulated FMCW-based reference signal.

In some examples of the method, apparatuses, and non-transitory computer-readable medium described herein, transmitting the FSK-modulated FMCW-based reference signal may include operations, features, means, or instructions for transmitting the FSK-modulated FMCW-based reference signal in accordance with the first set of parameters indicated via the first information and transmitting the FSK-modulated FMCW-based reference signal in accordance with a third set of parameters configured for FSK-modulated FMCW reference signals.

In some examples of the method, apparatuses, and non-transitory computer-readable medium described herein, transmitting the CSI report may include operations, features, means, or instructions for transmitting the CSI report via an orthogonal frequency division multiplexing (OFDM) channel.

In some examples of the method, apparatuses, and non-transitory computer-readable medium described herein, the FSK-modulated FMCW communications convey a stream of data bits, each bit of the stream of data bits may be modulated using a respective carrier frequency selected from among three or more candidate carrier frequencies, a quantity of the three or more candidate carrier frequencies from which the respective carrier frequency may be selected may be based on a frequency shifting interval over which a single carrier frequency may be applied and a bandwidth of the FSK-modulated FMCW communications, and the frequency shifting interval and the bandwidth may be based on the second set of parameters.

In some examples of the method, apparatuses, and non-transitory computer-readable medium described herein, the first set of parameters includes a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, a periodicity associated with the CSI report, or any combination thereof.

In some examples of the method, apparatuses, and non-transitory computer-readable medium described herein, the FMCW-based reference signal includes a CSI reference signal (CSI-RS).

A method for wireless communication at a first network node is described. The method may include transmitting first information that indicates a first set of parameters for generation of a CSI report associated with an FMCW communication type and receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

An apparatus for wireless communication at a first network node is described. The apparatus may include a communication interface and at least one processor coupled to the communication interface. The at least one processor may be configured to cause transmission of first information that indicates a first set of parameters for generation of a CSI report associated with an FMCW communication type and receive, via the communication interface before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Another apparatus for wireless communication at a first network node is described. The apparatus may include means for transmitting first information that indicates a first set of parameters for generation of a CSI report associated with an FMCW communication type and means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

A non-transitory computer-readable medium storing code for wireless communication at a first network node is described. The code may include instructions executable by a processor to transmit first information that indicates a first set of parameters for generation of a CSI report associated with an FMCW communication type and receive, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Some examples of the method, apparatuses, and non-transitory computer-readable medium described herein may further include operations, features, means, or instructions for communicating data with the second network node via the FSK-modulated FMCW communications based on the second set of parameters.

Some examples of the method, apparatuses, and non-transitory computer-readable medium described herein may further include operations, features, means, or instructions for transmitting second information that indicates a third set of parameters for the FSK-modulated FMCW communications between the first network node and the second network node, the third set of parameters being based on the second set of parameters and communicating data with the second network node via the FSK-modulated FMCW communications based on the third set of parameters.

In some examples of the method, apparatuses, and non-transitory computer-readable medium described herein, transmitting the second information may include operations, features, means, or instructions for transmitting an FSK-modulated FMCW signal, where the second information may be FSK-modulated with the FSK-modulated FMCW signal.

In some examples of the method, apparatuses, and non-transitory computer-readable medium described herein, transmitting the second information may include operations, features, means, or instructions for transmitting a control message including the second information.

Some examples of the method, apparatuses, and non-transitory computer-readable medium described herein may further include operations, features, means, or instructions for receiving a second FMCW-based reference signal, where the third set of parameters may be further based on measurement information corresponding to the second FMCW-based reference signal.

In some examples of the method, apparatuses, and non-transitory computer-readable medium described herein, transmitting the first information may include operations, features, means, or instructions for transmitting a CSI report configuration including the first information that indicates the first set of parameters. Some examples of the method, apparatuses, and non-transitory computer-readable medium described herein may further include operations, features, means, or instructions for transmitting the FMCW-based reference signal in accordance with a subset of FMCW parameters that may be included in the first set of parameters indicated via the CSI report configuration.

In some examples of the method, apparatuses, and non-transitory computer-readable medium described herein, transmitting the first information may include operations, features, means, or instructions for transmitting the FMCW-based reference signal including the first information, where the first information may be FSK modulated with the FMCW-based reference signal, and where the FMCW-based reference signal may be transmitted in accordance with an initial set of parameters configured for FSK-modulated FMCW reference signals based on the first information being FSK-modulated with the FMCW-based reference signal.

In some examples of the method, apparatuses, and non-transitory computer-readable medium described herein, receiving the CSI report may include operations, features, means, or instructions for receiving an FSK-modulated FMCW-based reference signal, where the CSI report may be FSK-modulated with the FSK-modulated FMCW-based reference signal.

In some examples of the method, apparatuses, and non-transitory computer-readable medium described herein, receiving the CSI report may include operations, features, means, or instructions for receiving the CSI report via an OFDM channel and receiving a second FMCW-based reference signal in accordance with FMCW parameters included in the second set of parameters indicated via the CSI report.

In some examples of the method, apparatuses, and non-transitory computer-readable medium described herein, the FSK-modulated FMCW communications convey a stream of data bits, each bit of the stream of data bits may be modulated using a respective carrier frequency selected from among three or more candidate carrier frequencies, a quantity of the three or more candidate carrier frequencies from which the respective carrier frequency may be selected may be based on a frequency shifting interval over which a single carrier frequency may be applied and a bandwidth of the FSK-modulated FMCW communications, and the frequency shifting interval and the bandwidth may be based on the second set of parameters.

In some examples of the method, apparatuses, and non-transitory computer-readable medium described herein, the first set of parameters includes a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, or a periodicity associated with the CSI report, or any combination thereof.

In some examples of the method, apparatuses, and non-transitory computer-readable medium described herein, the second set of parameters indicated via the CSI report includes a quantity of frequency shifting intervals, a frequency shifting interval duration, and a code rate.

A method for wireless communication at a first network node is described. The method may include generating an FSK-modulated FMCW to convey a stream of data bits, where generating the FSK-modulated FMCW includes, selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function, modulating the FSK-modulated FMCW using respective sinusoidal functions associated with the selected carrier frequencies, and transmitting the FSK-modulated FMCW that conveys the stream of data bits.

An apparatus for wireless communication at a first network node is described. The apparatus may include a communication interface and at least one processor coupled to the communication interface. The at least one processor may be configured to generate an FSK-modulated FMCW to convey a stream of data bits. To generate the FSK-modulated FMCW, the at least one processor may be configured to select, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function, modulate the FSK-modulated FMCW using respective sinusoidal functions associated with the selected carrier frequencies, and cause transmission of the FSK-modulated FMCW that conveys the stream of data bits.

Another apparatus for wireless communication at a first network node is described. The apparatus may include means for generating an FSK-modulated FMCW to convey a stream of data bits, where generating the FSK-modulated FMCW includes means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function, means for modulating the FSK-modulated FMCW using respective sinusoidal functions associated with the selected carrier frequencies, and means for transmitting the FSK-modulated FMCW that conveys the stream of data bits.

A non-transitory computer-readable medium storing code for wireless communication at a first network node is described. The code may include instructions executable by a processor to generate an FSK-modulated FMCW to convey a stream of data bits, where, to generate the FSK-modulated FMCW, the code may include instructions executable by a processor to select, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function, modulate the FSK-modulated FMCW using respective sinusoidal functions associated with the selected carrier frequencies, and transmit the FSK-modulated FMCW that conveys the stream of data bits.

Some examples of the method, apparatuses, and non-transitory computer-readable medium described herein may further include operations, features, means, or instructions for receiving information that indicates a set of parameters for the FSK-modulated FMCW, where the set of parameters includes a quantity of frequency shifting periods included in the set of multiple frequency periods, a duration of each frequency shifting period of the set of multiple frequency shifting periods, and a code rate for the FSK-modulated FMCW.

In some examples of the method, apparatuses, and non-transitory computer-readable medium described herein, a quantity of the three or more candidate carrier frequencies may be based on a frequency shift interval and a bandwidth of the FSK-modulated FMCW.

In some examples of the method, apparatuses, and non-transitory computer-readable medium described herein, a quantity of data bits that may be included in the subset of one or more data bits conveyed via a single frequency shifting period may be based on a spreading factor of the FSK-modulated FMCW, a quantity of the three or more candidate carrier frequencies, and a quantity of frequency shifting periods included in the set of multiple frequency shifting periods.

### BRIEF DESCRIPTION OF THE DRAWINGS

FIG. 1 illustrates an example of a wireless communication system that supports channel state information (CSI) reporting for transmissions via frequency shift keying (FSK)-modulated frequency modulated continuous waveforms (FMCW) in accordance with one or more aspects of the present disclosure.

FIGS. 2A and 2B illustrate examples of FMCW-based channel estimation schemes in accordance with one or more aspects of the present disclosure.

FIG. 3 illustrates examples of FMCW configurations in accordance with one or more aspects of the present disclosure.

FIG. 4 illustrates an example of an FSK-modulated FMCW communication scheme that supports CSI reporting for transmissions via FSK-modulated FMCWs in accordance with one or more aspects of the present disclosure.

FIG. 5 illustrates an example of an FSK-modulated FMCW configuration that supports CSI reporting for transmissions via FSK-modulated FMCWs in accordance with one or more aspects of the present disclosure.

FIG. 6 illustrates an example of a wireless communication system that supports CSI reporting for transmissions via FSK-modulated FMCWs in accordance with one or more aspects of the present disclosure.

FIG. 7 illustrates an example of a process flow that supports CSI reporting for transmissions via FSK-modulated FMCWs in accordance with one or more aspects of the present disclosure.

FIGS. 8A and 8B illustrate examples of FSK-modulated FMCW configurations that support CSI reporting for transmissions via FSK-modulated FMCWs in accordance with one or more aspects of the present disclosure.

FIG. 9 illustrates an example of an FMCW-based FSK modulation and demodulation scheme in accordance with one or more aspects of the present disclosure.

FIG. 10 illustrates an example of a process flow that supports CSI reporting for transmissions via FSK-modulated FMCWs in accordance with one or more aspects of the present disclosure.

FIGS. 11 and 12 illustrate block diagrams of devices that support CSI reporting for transmissions via FSK-modulated FMCWs in accordance with one or more aspects of the present disclosure.

FIG. 13 illustrates a block diagram of a communications manager that supports CSI reporting for transmissions via FSK-modulated FMCWs in accordance with one or more aspects of the present disclosure.

FIG. 14 illustrates a diagram of a system including a UE that supports CSI reporting for transmissions via FSK-modulated FMCWs in accordance with one or more aspects of the present disclosure.

FIG. 15 illustrates a diagram of a system including a network entity that supports CSI reporting for transmissions via FSK-modulated FMCWs in accordance with one or more aspects of the present disclosure.

FIGS. 16 through 21 illustrate flowcharts showing methods that support CSI reporting for transmissions via FSK-modulated FMCWs in accordance with one or more aspects of the present disclosure.

### DETAILED DESCRIPTION

Frequency modulated continuous waveform (FMCW) signals may be used for wireless sensing, or wireless communications, or both. However, using FMCW signals for some communication types, such as long range (LoRa) communications, may be relatively inefficient due to a tradeoff between sensing range and data rate. Frequency shift keying (FSK) may be applied to FMCW signals (referred to as FSK-modulated FMCW-based transmissions) to improve efficiency. As part of FSK modulation, an FMCW signal may be divided into frequency shifting periods, and each frequency shifting period may be modulated using one of two sinusoidal signals each associated with a respective frequency (referred to as candidate frequencies or carrier frequencies) based on a value of a data bit to be conveyed via the respective frequency shifting period.

Techniques, systems, and devices described herein provide for network nodes to exchange signaling to indicate parameters for FSK-modulated FMCW communications (e.g., a quantity or duration of frequency shift periods, a code rate, a bandwidth, an FMCW slope, an FMCW chirp duration, and other parameters), which may improve throughput and communication reliability. The network nodes described herein may exchange channel state information (CSI) associated with an FMCW communication type (e.g., an FMCW-based CSI report). In order for a first network node (e.g., a user equipment (UE) or some other type of network node) to measure and determine CSI based on FMCW communications, the first network node may first be configured with parameters for the CSI measurement associated with the FMCW communication type. To this end, a second network node (e.g., a network entity or some other type of network node) may transmit, to the first network node, information that indicates the parameters for determining CSI. The information may be FSK modulated with an FMCW-based CSI reference signal (CSI-RS) or via another message separate from the FMCW-based CSI-RS.

The first network node may receive the FMCW-based CSI-RS and may generate a CSI report that includes parameters determined by the first network node for subsequent FSK-modulated FMCW communications. The first network node may determine the parameters based on measurement information corresponding to the FMCW-based CSI-RS. The first network node may transmit the CSI report to the second network node. Subsequent communications between the first and second network nodes may be based on the indicated parameters. The parameters may include one or more of a quantity of frequency shifting periods, a frequency shifting interval (e.g., a quantity of bits per frequency shifting period), and a code rate. The initial CSI configuration, the CSI report, or both may be communicated via FSK-modulated FMCW-based signals or other signals (e.g., OFDM transmissions) based on a capability of the first network node to transmit and receive FMCW-based signals or both FMCW-based signals and other communication signals.

In some aspects described herein, a transmitting network node may use more than two candidate frequencies for the FSK modulation of the FMCW-based signals and communications. When generating an FSK-modulated FMCW, a transmitting network node may select from three or more candidate frequencies based on a value of a data bit stream to be conveyed via the FSK-modulated FMCW. The transmitting network node may apply a sinusoidal function associated with the selected frequency to the FMCW per frequency shifting period. The quantity of candidate frequencies may be based on a frequency shifting interval and a bandwidth of the signal. By increasing the quantity of candidate frequencies, the network nodes may support increased data rate and communication throughput.

Aspects of the disclosure are initially described in the context of wireless communication systems. Additional aspects are described in the with reference to FMCW-based channel estimation schemes, FMCW configurations, FSK-modulated FMCW-based communication schemes, FSK-modulated FMCW configurations.

Aspects of the disclosure are further illustrated by and described with reference to apparatus diagrams, system diagrams, and flowcharts that relate to CSI reporting for transmissions via FSK-modulated FMCWs.

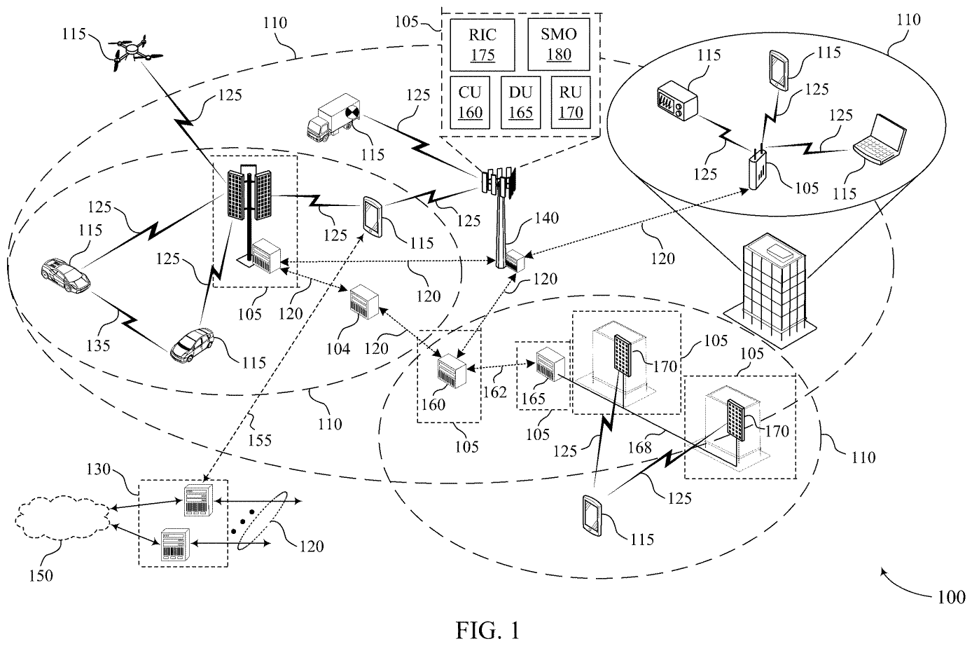

FIG. 1 illustrates an example of a wireless communication system 100 that supports CSI reporting for transmissions via FSK-modulated FMCWs in accordance with one or more aspects of the present disclosure. The wireless communication system 100 may include one or more network entities 105, one or more UEs 115, and a core network 130. In some aspects, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity 105, or a wireless node) may include, be, or be included in (e.g., be a component of) a base station 140 (e.g., any base station 140 described herein), a UE 115 (e.g., any UE 115 described herein), a network controller, an apparatus, a device, a computing system, an integrated access and backhauling (IAB) node, a distributed unit (DU) 160, a central unit (CU) 165, a remote/radio unit (RU) 170 (which may also be referred to as a remote radio unit (RRU)), and/or another processing entity configured to perform any of the techniques described herein. For example, a network node may be a UE 115. As another example, a network node may be a base station 140 or network entity 105. As another example, a first network node may be configured to communicate with a second network node or a third network node. In one aspect of this example, the first network node may be a UE 115, the second network node may be a base station 140, and the third network node may be a UE 115. In another aspect of this example, the first network node may be a UE 115, the second network node may be a base station 140, and the third network node may be a base station 140. In yet other aspects of this example, the first, second, and third network nodes may be different relative to these examples. Similarly, reference to a UE 115, base station 140, apparatus, device, computing system, or the like may include disclosure of the UE 115, base station 140, apparatus, device, computing system, or the like being a network node. For example, disclosure that a UE 115 is configured to receive information from a base station 140 also discloses that a first network node is configured to receive information from a second network node. Consistent with this disclosure, once a specific example is broadened in accordance with this disclosure (e.g., a UE 115 is configured to receive information from a base station 140 also discloses that a first network node is configured to receive information from a second network node), the broader example of the narrower example may be interpreted in the reverse, but in a broad open-ended way. In the example above where a UE 115 is configured to receive information from a base station 140 also discloses that a first network node is configured to receive information from a second network node, the first network node may refer to a first UE 115, a first base station, a first apparatus, a first device, a first computing system, a first set of one or more one or more components, a first processing entity, or the like configured to receive the information; and the second network node may refer to a second UE 115, a second base station 140, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communication systems (e.g., wireless communication system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CSI reporting for transmissions via FSK-modulated FMCWs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communication system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communication system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications using a particular carrier bandwidth or may be configurable to support communications using one of a set of carrier bandwidths. In some aspects, the wireless communication system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some aspects, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communication system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communication system 100 may support integrated sensing and communication (ISAC). ISAC may utilize shared radio frequency and baseband hardware for sensing and communication, which may reduce costs and complexity. ISAC may additionally, or alternatively, support an always-on availability of spectrum for both use cases, which may improve spectrum effectiveness. ISAC may support multiple use cases, including macro sensing, micro sensing, and sensing assisted communication (e.g., beam management). Examples of macro sensing use cases may include meteorological monitoring, autonomous driving, dynamic map, low-altitude airspace (e.g., unmanned aerial vehicle (UAV)) management, or intruder detection, among other example use cases. Examples of micro sensing use cases may include gesture recognition, vital signal detection, or high resolution imaging, among other use cases.

In some aspects, one or more network nodes in the wireless communication system 100 may support FSK-modulated FMCW signaling for ISAC. Techniques, systems, and devices described herein provide for network nodes to exchange signaling to indicate parameters for FSK-modulated FMCW communications (e.g., a quantity or duration of frequency shift periods, a code rate, a bandwidth, an FMCW slope, an FMCW chirp duration, and other parameters), which may improve throughput and communication reliability associated with ISAC and other communication types. The network nodes described herein may exchange CSI associated with an FMCW communication type (e.g., an FMCW-based CSI report). In order for a first network node (e.g., a UE 115 or some other type of network node) to measure and determine CSI based on FMCW communications, the first network node may first be configured with parameters for the CSI measurement associated with the FMCW communication type. To this end, a second network node (e.g., a network entity 105 or some other type of network node) may transmit, to the first network node, information that indicates the parameters for determining CSI. The information may be FSK modulated with an FMCW-based CSI-RS or via another message separate from the FMCW-based CSI-RS.

The first network node may receive the FMCW-based CSI-RS and may generate a CSI report that includes parameters determined by the first network node for subsequent FSK-modulated FMCW communications. The first network node may determine the parameters based on measurement information corresponding to the FMCW-based CSI-RS. The first network node may transmit the CSI report to the second network node. Subsequent communications between the first and second network nodes may be based on the indicated parameters. The parameters may include one or more of a quantity of frequency shifting periods, a frequency shifting interval (e.g., a quantity of bits per frequency shifting period), and a code rate. The initial CSI configuration, the CSI report, or both may be communicated via FSK-modulated FMCW-based signals or other signals (e.g., OFDM transmissions) based on a capability of the first network node to transmit and receive FMCW-based signals or both FMCW-based signals and other communication signals.

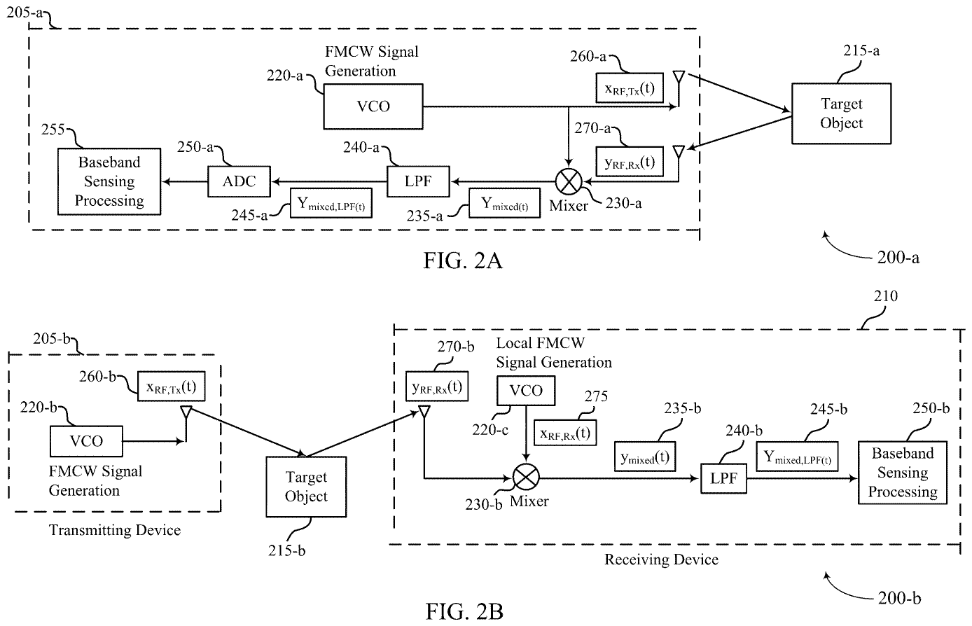

FIGS. 2A and 2B illustrate examples of FMCW-based channel estimation schemes 200-a and 200-b that support CSI reporting for transmissions via FSK-modulated FMCWs in accordance with one or more aspects of the present disclosure. In some aspects, the FMCW-based channel estimation schemes 200-a and 200-b may implement or be implemented by aspects of the wireless communication system 100 described with reference to FIG. 1. In this aspect, a device 205 (e.g., a UE, a base station, an RU, a DU, a CU, an IAB node or some other network node) may transmit an FMCW signal. The FMCW signal may, in some aspects, be a reference signal or some other signal configured for sensing.

FIG. 2A represents a first FMCW-based channel estimation scheme 200-a, in which monostatic sensing is performed using the FMCW signal. That is, the transmitter and receiver used for sensing may be collocated at a single device, such as the device 205-a (referred to as a transmitting device, or a receiving device, or both, in some aspects). The device 205-a may generate an FMCW-based reference signal 260-a and may transmit the FMCW-based reference signal 260-a. The device 205-a may receive the FMCW-based reference signal 260-a after the reference signal reflects off of a target object 215-a or some other object or material in the environment (e.g., a neighboring device, a building, a vehicle, or some other object). The device 205-a may use measurements of the FMCW-based reference signal 260-a to measure or estimate a distance, location, or velocity of the target object 215-a.

The device 205-a may utilize a voltage controlled oscillator (VCO) 220-a to perform the FMCW signal generation. The device 205-a may generate the FMCW-based reference signal 260-a in an analog domain using the VCO 220-a. The device 205-a may transmit the FMCW-based reference signal 260-a using at least one antenna element at the device 205-a. The analog domain FMCW-based reference signal 260-a generated and transmitted by the device 205-a may be represented by x_{RF,Tx}(t), shown in Equation 1.

$${x}_{R F , T x} ( t ) = cos ( 2 π ( {f}_{c} + \frac{S}{2} t ) t + {ϕ}_{T x} ) \qquad ( 1 )$$

As shown in Equation 1, the FMCW-based reference signal 260-a may be a time-domain signal (e.g., a function of time (t)). In Equation 1, f_{c} may represent a starting frequency of the FMCW-based reference signal 260-a, S may represent a slope of the FMCW-based reference signal 260-a, and φ_{Tx} may represent a phase of the transmitting device 205-a (e.g., a gNB or some other network node).

The FMCW-based reference signal 260-a may be associated with a waveform signal transmitted via a duration (e.g., a duration of an OFDM symbol of an OFDM channel) in the time domain and a bandwidth (e.g., BW) in the frequency domain. The FMCW-based reference signal 260-a may span frequencies between the starting frequency f_{c} and a sum of the starting frequency and the bandwidth (e.g., {f_{c}, f_{c}+BW}). The transmit frequency may increase with time (e.g., f_{Tx}(t)=f_{c}+St). That is, the slope, S, of the FMCW-based reference signal 260-a may correspond to a quotient of the bandwidth and a duration of the symbol via which the FMCW-based reference signal 260-a is transmitted, as shown by Equation 2.

$$S = \frac{B W}{{T}_{s y m}} = \frac{{N}_{R E} \cdot Δ f}{{T}_{s y m}} \qquad ( 2 )$$

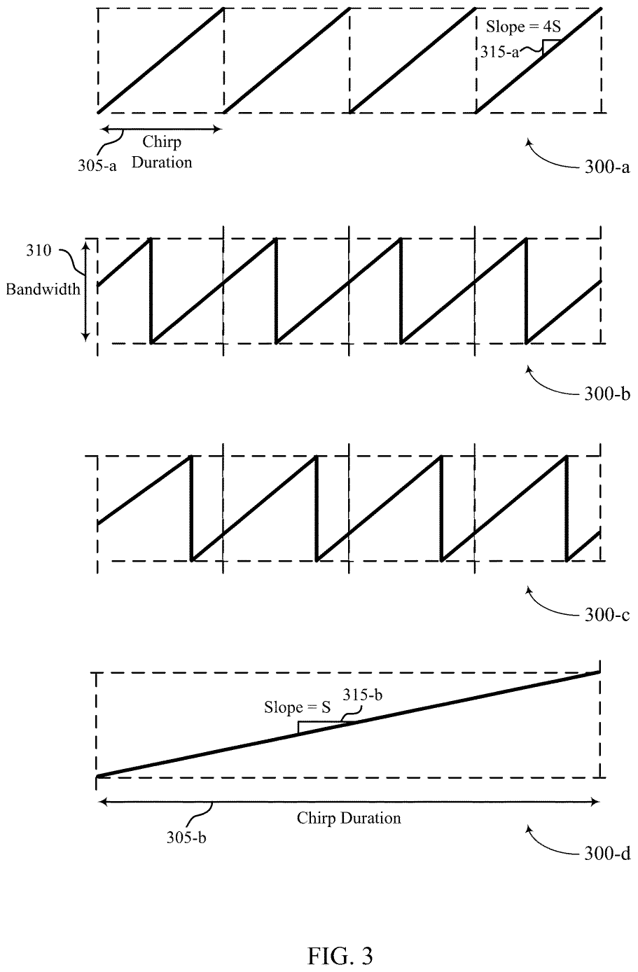

In Equation 2, T_{sym} may represent the duration of the symbol, N_{RE} may represent a quantity of resource elements in the bandwidth, and Δf may represent a subcarrier spacing (SCS). The structure of FMCW-based signals, such as the FMCW-based reference signal 260-a, is described in further detail elsewhere herein, including with reference to FIG. 3.

The FMCW-based reference signal 260-a may bounce or reflect off of one or more objects in the environment surrounding the device 205-a, such as the target object 215-a. The received FMCW signal 270-a that is received by the device 205-a in response to the FMCW-based reference signal 260-a transmitted by the device 205-a may be represented by y_{RF,Rx}(t), shown in Equation 3.

$${y}_{RF , Rx} ( t ) = {\sum }_{p = 0}^{P - 1} {A}_{{p}^{x} R F , T x} ( t - {τ}_{p} ) + n ( t ) \qquad ( 3 )$$

In Equation 3, P may represent a quantity of channel delay paths (e.g., a quantity of multi-paths) associated with a channel between the device 205-a and the target object 215-a and ty may represent a given channel delay with index p. That is, the received FMCW signal 270-a may be sampled over various channel delays (e.g., p=0 to P−1). Aₚ may represent a complex gain of a given path p, and n(t) may represent channel noise.

The device 205-a may generate a combined FMCW signal 235-a (e.g., y_{mixed}(t)). To generate the combined FMCW signal 235-a, the device 205-a may combine the received FMCW signal 270-a with the previously generated FMCW-based reference signal 260-a using a mixer 230-a. The mixer 230-a may represent one or more components (e.g., hardware, software, or both) of the device 205-a that are configured to combine two or more time-domain FMCW signals.

The device 205-a may filter the combined FMCW signal 235-a using a low pass filter (LPF) 240-a at the device 205-a. The LPF 240-a may generate a combined and filtered FMCW signal 245-a (e.g., y_{mixed,LPF}(t)). The LPF 240-a may represent a component of the device 205-a that is configured to filter signals, or a function supported by the device 205-a, or both. For example, the device 205-a may apply an LPF function to the combined FMCW signal 235-a (e.g., y_{mixed,LPF}(t)=LPF[y_{RF,Rx}(t)x_{RF,UE}(t)]). The combined and filtered FMCW signal 245-a may be represented by Equation 4.

$${y}_{mixed , LPF} ( t ) = {\sum }_{p = 0}^{P - 1} {β}_{p} exp ( - j 2 π S {τ}_{p} \cdot t ) , where \qquad ( 4 )$$

$${β}_{p} = \frac{{A}_{p}}{2} exp ( - j ( 2 π {f}_{c} {τ}_{p} ) ) exp ( j ( 2 π ( \frac{S}{2} {τ}_{p} ) {τ}_{p} - {ϕ}_{R x} + {ϕ}_{T x} ) )$$

After combining and filtering the FMCW signals, the device 205-a may use an ADC 250-a to sample the combined and filtered FMCW signal 245-a in the time domain. The device 205-a may subsequently perform DFT on the combined and filtered FMCW signal 245-a to estimate delay values (e.g., {Tp}) in the combined and filtered FMCW signal 245-a. The device 205-a may, as part of the baseband sensing processing 255, measure a propagation distance between the transmitting antenna (e.g., a “radar transmission”), the target object 215-a, and the receiving antenna (e.g., a “radar reception”). The device 205-a may thereby generate and transmit FMCW-based reference signals and use reflections of the FMCW-based reference signals to perform monostatic sensing (e.g., monostatic sensing based on transmission and reception of FMCW chirps).

FIG. 2B represents a second FMCW-based channel estimation scheme 200-b, in which bistatic sensing may be performed using FMCW signals. In this aspect, a transmitter used for sensing and a receiver used for the sensing may be connected via a communication link (e.g., an LTE, NR, or Wi-Fi communication link, or some other type of bistatic communication link). By utilizing FMCW-based signals (e.g., FMCW chirps) to support bistatic sensing, a transmitting device 205-b and a receiving device 210 may support reduced resource utilization, latency, processing, cost, and complexity as compared with other types of sensing signals, among other advantages.

The transmitting device 205-b may generate an FMCW-based reference signal 260-a (e.g., a first FMCW signal). In some aspects, the transmitting device 205-b may generate the FMCW-based reference signal 260-b in an analog domain using a VCO 220-b. The transmitting device 205-b may transmit the FMCW-based reference signal 260-b using at least one antenna element at the transmitting device 205-b. The analog domain FMCW-based reference signal 260-b generated and transmitted by the transmitting device 205-b may be represented by x_{RF,Tx}(t), shown in Equation 5.

$${x}_{R F , T x} ( t ) = cos ( 2 π ( {f}_{c} + \frac{S}{2} t ) t + {ϕ}_{T x} ) \qquad ( 5 )$$

The FMCW-based reference signal 260-b may be similar to or the same as the FMCW-based reference signal 260-a described with reference to FIG. 2A. In one aspect, the FMCW-based reference signal 260-b may be a time-domain signal (e.g., a function of time (t)). f_{c} may represent a starting frequency of the FMCW-based reference signal 260-b, S may represent a slope of the FMCW-based reference signal 260-b, and φ_{Tx} may represent a phase of the transmitting device 205-b.

The FMCW-based reference signal 260-b may be transmitted via a channel between the transmitting device 205-b and the receiving device 210. In some aspects, the FMCW-based reference signal 260-b may reflect or bounce off of a target object 215-b in the channel between the transmitting device 205-b and the receiving device 210. The devices may use measurements of the FMCW-based reference signal 260-b to measure or estimate a distance, location, or velocity of the target object 215-b.

The radio frequency FMCW signal 270-b that is received by the receiving device 210 in response to the FMCW-based reference signal 260-b transmitted by the transmitting device 205-b may be represented by y_{RF,Rx} (t), shown in Equation 6.

$${y}_{RF , Rx} ( t ) = {\sum }_{p = 0}^{P - 1} {A}_{{p}^{x} R F , T x} ( t - {τ}_{p} ) + n ( t ) \qquad ( 6 )$$

The FMCW signal 270-b that is received by the receiving device 210 may be similar to or the same as the FMCW signal 270-a that is described with reference to FIG. 2A, in some aspects. For example, P may represent a quantity of channel delay paths (e.g., a quantity of multi-paths) associated with a channel between the transmitting device 205-b, the target object 215-b, and the receiving device 210, and τₚ may represent a given channel delay with index p. That is, the received FMCW signal 270-b may be sampled over various channel delays (e.g., p=0 to P−1). Aₚ may represent a complex gain of a given path p, and n(t) may represent channel noise.

As described herein, the receiving device 210 may generate an FMCW signal 275 at the receiving device 210. The FMCW signal 275 generated at the receiving device 210 may be referred to as a second FMCW signal or a local FMCW signal. The receiving device 210 may generate the FMCW signal 275 in the analog domain using a VCO 220-c at the receiving device 210. The receiving device 210 may generate the FMCW signal 275 at the same time as or after receiving the FMCW signal 270-b. The FMCW signal 275 generated by the receiving device 210 may be represented by x_{RF,Rx}(t), shown in Equation 7.

$${x}_{RF , Rx} ( t ) = exp ( - j ( 2 π ( {f}_{c} + \frac{S}{2} t ) t + {ϕ}_{R x} ) ) \qquad ( 7 )$$

The FMCW signal 275 generated by the receiving device 210 may have a same starting frequency and slope as the FMCW signal 260-b generated by the transmitting device 205-b. In Equation 7, φ_{Rx} may represent a phase of the receiving device 210. In some aspects, the phase of the receiving device 210 may be the same as the phase of the transmitting device 205-b (e.g., φ_{Tx}=φ_{Rx}).

After generating the FMCW signal 275, the receiving device 210 may generate a combined FMCW signal 235-b (e.g., y_{mixed}(t)). To generate the combined FMCW signal 235-b, the receiving device 210 may combine the FMCW signal 270-b received at the receiving device 210 with the locally generated FMCW signal 275 using a mixer 230-b. The mixer 230-b may represent one or more components (e.g., hardware, software, or both) of the receiving device 210 that are configured to combine two or more time-domain FMCW signals. In some aspects, the combining may include multiplying the FMCW signals (e.g., y_{mixed}(t)=y_{RF,Rx}(t) x_{RF,Rx}(t)).

The receiving device 210 may filter the combined FMCW signal 235-b using an LPF 240-b at the receiving device 210. The LPF 240-b may generate a combined and filtered FMCW signal 245-b (e.g., y_{mixed,LPF}(t)). The LPF 240-b may represent a component of the receiving device 210 that is configured to filter signals, or a function supported by the receiving device 210, or both. For example, the receiving device 210 may apply an LPF function to the combined FMCW signal 235-b (e.g., y_{mixed,LPF}(t)=LPF[y_{RF,Rx}(t)x_{RF,UE}(t)]). The combined and filtered FMCW signal 245-b may be represented by Equation 8.

$${y}_{mixed , LPF} ( t ) = {\sum }_{p = 0}^{P - 1} {β}_{p} exp ( - j 2 π S {τ}_{p} \cdot t ) , where \qquad ( 8 )$$

$${β}_{p} = \frac{{A}_{p}}{2} exp ( - j ( 2 π {f}_{c} {τ}_{p} ) ) exp ( j ( 2 π ( \frac{S}{2} {τ}_{p} ) {τ}_{p} - {ϕ}_{R x} + {ϕ}_{T x} ) )$$

After combining and filtering the FMCW signals, the receiving device 210 may perform baseband sensing processing 250-b using the combined and filtered FMCW signal 245-b. In some aspects, the baseband sensing processing 250-b may include using an ADC or other component of the receiving device 210 to sample the combined and filtered FMCW signal 245-b in the time domain. A sampling rate used to sample the combined and filtered FMCW signal 245-b may be Fₛ.

The sampling by the receiving device 210 as part of the baseband sensing processing 250-b may produce a sampling sequence, D_{Rx}(k), which may represent a set of values associated with the channel estimation. The sampling sequence, D_{Rx}(k), is shown by Equation 9.

$${D}_{R x} ( k ) = {\sum }_{p = 0}^{P - 1} {β}_{p} exp ( - j 2 π S {τ}_{p} \cdot \frac{k}{{F}_{s}} ) \qquad ( 9 )$$

In Equation 9, Fₛ may represent the sampling rate used by the receiving device 210 to estimate the channel. K may represent a total quantity of subbands in the channel, which may also correspond to a total quantity of samples in the sampling sequence. Accordingly, each value of k may represent an index of a respective subband of the total quantity of subbands. The receiving device 210 may estimate the multi-path delays (e.g., {τₚ}) by analyzing the frequency components of the sampling sequence D_{Rx}(k).

The receiving device 210 may thereby estimate a frequency domain channel using time domain signal processing based on FMCW-based signaling. The described FMCW-based channel estimation techniques may be performed by the receiving device 210 in the time domain using time domain signal processing. That is, the receiving device 210 may refrain from applying FFT or other frequency transforms when using the FMCW signals to estimate the frequency domain channel. FMCW signaling structures are described in further detail elsewhere herein, including with reference to FIG. 3.

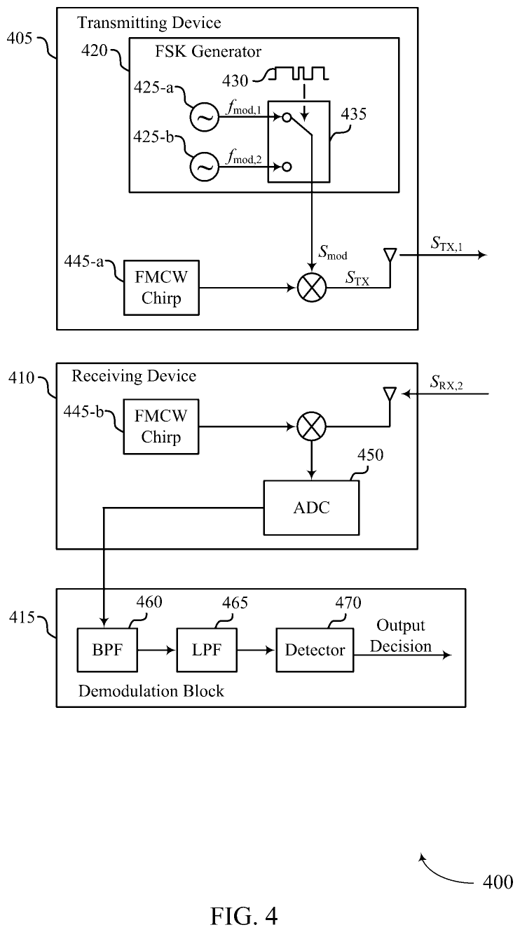

Techniques, systems, and devices described herein provide for data and other information to be FSK modulated with the described FMCW signals. The transmitting and receiving devices may exchange signaling to indicate parameters for the FSK-modulated FMCW communications and may exchange CSI based on the FSK-modulated FMCW communications in accordance with the parameters, as described in further detail elsewhere herein, including with reference to FIGS. 4-10.

FIG. 3 illustrates examples of FMCW configurations 300 that supports CSI reporting for transmissions via FSK-modulated FMCWs in accordance with one or more aspects of the present disclosure. The FMCW configurations 300 (e.g., FMCW configurations 300-a, 300-b, 300-c, and 300-d) may implement or be implemented by aspects of the wireless communication system 100 and the FMCW-based channel estimation schemes 200 described with reference to FIGS. 1 and 2. For example, the FMCW configurations 300 illustrate example FMCW chirps having different cyclic shifts, slopes, and durations, among other FMCW parameters.

FMCW signals may be characterized by a continuous increase or decrease of frequency with a fixed slope over time. An FMCW may include one or more portions or segments, which may be referred to as FMCW chirps in some aspects herein. A duration of each segment may be referred to as a chirp duration 305. In one aspect, if an FMCW is transmitted via an OFDM channel, each FMCW chirp duration 305 may be the same as an OFDM symbol duration. The frequency of the FMCW may span across a bandwidth 310 of the FMCW in each chirp duration 305. The bandwidth 310 may start at a starting frequency (e.g., f_{c}, as described with reference to FIG. 2). The slope 315 of each chirp may be equal to a quotient of the bandwidth 310 over the chirp duration 305

$$( e . g . , \frac{B W}{{T}_{s y m}} ) ,$$

as described in further detail elsewhere herein, including with reference to Equation 2. In the example of FIG. 3, the bandwidth 310 of the FMCW configuration 300-a and the FMCW configuration 300-d may be the same, but the chirp durations 305-a and 305-b may be different. As such, the slope 315-b of the FMCW configuration 300-d may be less than the slope 315-a of the FMCW configuration 300-a because the frequency of the FMCW configuration 300-d may increase over the same bandwidth 310 during a longer chirp duration 305-b than the chirp duration 305-a. If the chirp duration 305-b is four times longer than the chirp duration 305-a, the slope 315-b may be four times smaller than the slope 315-a (e.g., the slope 315-a may be equal to 4S and the slope 315-b may be equal to S).

In some aspects, different FMCWs may have different cyclic shift values. In the example of FIG. 3, each of the FMCW configurations 300-a, 300-b, and 300-c may each have a same chirp duration 305-a and a same slope 315-a, but different cyclic shift values, where the cyclic shift values may represent time positions for a starting point of an FMCW chirp. A quantity of cyclic shifts may be based on a spreading factor (SF) that is used. For example, an FMCW chirp may have 2^{SF} cyclic shift values with an interval of

$$\frac{{T}_{chirp}}{{2}^{S F}} ,$$

where T_{chirp} represents the chirp duration 305. Thus any cyclic shift with granularity of

$$\frac{{T}_{chirp}}{{2}^{SF}}$$

may be realized. A transmitting device may select one cyclic shift value from among a set of 2^{SF} cyclic shift values (e.g., s*∈{0, 1, . . . , 2^{SF}−1}) based on a sequence of SF data bits. The transmitting device may transmit the cyclic shift FMCW chirp according to Equation 10. As such, a quantity of up to SF bits may be represented by selecting one cyclic shift value for one FMCW chirp.

$${x}_{RF , Tx} ( mod ( t + \frac{{s}^{*}}{{2}^{SF}} {T}_{chirp} , {T}_{chirp} ) ) \qquad ( 10 )$$

In some aspects, as the spreading factor increases, a data rate of the FMCW transmission may increase (e.g., more bits in one FMCW chirp), but post-processing SNR may decrease. A receiver may receive the FMCW, detect which cyclic shift value is used, and then retrieve the transmitted data bits. Accordingly, FMCW communications may be suitable for different communication scenarios, such as long range (LoRa) communication technologies (e.g., LoRa within low power wide area networks (LP-WAN)). LoRa may be categorized as a chirp spread spectrum (CSS)-based modulation scheme. The CSS-based modulation scheme may be suitable for relatively low signal-to-interference and noise ratio (SINR) by using an efficient tradeoff between bandwidth and data rates when a signal is subject to noise (e.g., down to −149 decibel milliwatts (dBm)). Additionally, or alternatively, the CSS-based modulation scheme may be suitable for in-band interference and fading because a CSS receiver may accurately decode packets in the presence of relatively high in-band interference (e.g., 95 decibels (dB) or higher).

Each FMCW chirp may be shifted in the time domain, the frequency domain, or both. The frequency increase or decrease of the FMCW chirp may be continuous with a fixed slope 315. Accordingly, during LoRa communications, each FMCW chirp may be modulated or demodulated once during each chirp duration 305. If multi-path propagation exists, an interval between available cyclic shifts may be greater than a largest path delay (τₘₐₓ). As such, a maximum quantity of candidate cyclic shift values may be equal to

$$\frac{BW}{S {τ}_{max}} .$$

There may be a tradeoff between sensing range and communication throughput for LoRa communications, in some aspects. A sensing range of the FMCW may be based on the chirp duration

$$( e . g . , maximum sensing range = \frac{{F}_{s} c}{4 S} = \frac{{F}_{s} {cT}_{chirp}}{4 BW} , \\ where {F}_{s} is a sampling rate and c is light speed ) .$$

Accordingly, to increase sensing range, the chirp duration 305 may be increased. The data rate of FMCW communications (e.g., throughput) may also be based on the chirp duration 305. For example, the data rate may be equal to

$$\frac{SF}{{2}^{SF}} BW ,$$

and the chirp duration 305 may be equal to

$$\frac{{2}^{SF}}{BW} .$$

Thus, the data rate may be inversely proportional to the chirp duration 305, such that the chirp duration 305 may be decreased to increase data rate and throughput (e.g., as long as a product of the pre-SNR and 2^{SF} is equal to a satisfactory post-SNR). Accordingly, FMCW-based LoRa communications may be relatively inefficient. Techniques for improved integrated sensing and communication signaling may be beneficial.

Techniques, systems, and devices described herein provide for data and other information to be FSK modulated with the described FMCW signals. The transmitting and receiving devices may exchange signaling to indicate parameters for the FSK-modulated FMCW communications and may exchange CSI based on the FSK-modulated FMCW communications in accordance with the parameters, as described in further detail elsewhere herein, including with reference to FIGS. 4-10.

FIG. 4 illustrates an example of an FSK-modulated FMCW communication scheme 400 that supports CSI reporting for transmissions via FSK-modulated FMCWs in accordance with one or more aspects of the present disclosure. The FSK-modulated FMCW communication scheme 400 may implement or be implemented by aspects of the wireless communication system 100, as described with reference to FIG. 1. For example, a transmitting device 405 (e.g., a UE, a base station, an RU, a DU, a CU, an IAB node or some other network node) may generate and transmit an FSK-modulated FMCW signal to a receiving device 410 (e.g., a UE, a base station, an RU, a DU, a CU, an IAB node or some other network node). The FSK-modulated FMCW signal may, in some aspects, be a reference signal or some other signal configured for sensing.

Although a transmitting device 405 and a receiving device 410 are illustrated in FIG. 4, it is to be understood that the FSK-modulated FMCW signaling described herein may be utilized for monostatic sensing or bistatic sensing, or other types of communications. The transmitting device 405 may generate and transmit an FSK-modulated FMCW-based signal (S_{TX,1}). For monostatic sensing, the transmitting device 405 may receive the FSK-modulated FMCW-based signal after the signal reflects off of a target object and may use measurements of the FSK-modulated FMCW-based signal to measure or estimate a distance, location, or velocity of the target object. For bistatic sensing and communications, the receiving device 410 may receive the FSK-modulated FMCW-based signal from the transmitting device 405 or after the FSK-modulated FMCW-based signal reflects off of a target object and may decode the FSK-modulated FMCW-based signal to estimate parameters associated with the transmitting device 405, the target object, or to obtain information conveyed via the FSK-modulated FMCW-based signal, or any combination thereof.

The transmitting device 405 may utilize an FSK generator 420 to generate the FSK-modulated FMCW-based signal. The FSK generator 420 may be any component including hardware, software, or both configured to generate an FSK-modulated FMCW-based signal. The FSK generator 420 may start with a data stream 430 (e.g., a stream of data bits to be conveyed via the FSK-modulated FMCW-based signal). The FSK generator 420 may select a cosine signal 425 from a set of two cosine signals 425-a and 425-b (e.g., s_{mod,1}(t) and s_{mod,2}(t)). The selection may be performed using a selector 435, which may include one or more switches. One bit in the data stream 430 may control whether the cosine signal 425-a or the cosine signal 425-b is selected by the selector 435. The selected cosine signal 425 may be represented by Equation 11.

$${s}_{mod , m} = {A}_{mod , m} cos ( 2 π {f}_{mod , m} t + {φ}_{mod , m} ) + {dc}_{mod , m} \qquad ( 11 )$$

In Equation 11, m may represent an index of the selected cosine signal 425, and f_{mod,m} may represent a frequency shift value or carrier frequency associated with the selected cosine signal 425. The transmitting device 405 may multiply the selected cosine signal 425 (S_{mod}) to the FMCW chirp 445-a. The transmitting device 405 may transmit the FSK-modulated FMCW signal (S_{TX,1}) via an antenna element of the transmitting device 405.

The receiving device 410 may receive the FSK-modulated FMCW signal (S_{RX,2}) via an antenna element of the receiving device 410. The receiving device 410 may multiply the received signal with an FMCW chirp 445-b. The receiving device 410 may perform FMCW receiver processing, as described with reference to FIGS. 2A and 2B. In some aspects, the receiving device 410 may convert the received signal to digital form using an ADC 450, and may transfer the converted signal to a demodulation block 415 for further processing. For example, the demodulation block 415 may include a band pass filter (BPF) 460, an LPF 465, and a detector 470, among other components. After performing the FMCW receiver processing, the receiving device 410 may use the output signal to perform frequency analysis. A detected frequency may correspond to a transmitted bit of the data stream 430.

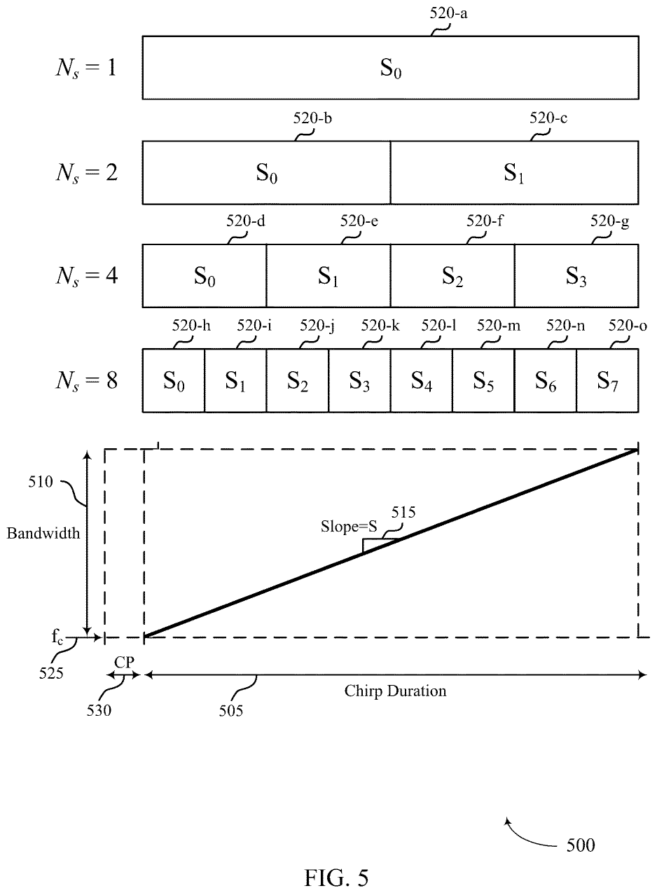

By adding a mixer at the transmitting device 405, the frequency shifting by multiplying a selective cosine signal 425 may be performed at any time and any duration. As such, the FSK-modulated FMCW communications described herein may be relatively more efficient and flexible as compared with FMCW communications, in some aspects. Techniques, systems, and devices described herein provide for the transmitting and receiving devices to facilitate more reliable FSK-modulated FMCW communications by exchanging signaling to indicate parameters for the FSK-modulated FMCW communications. The devices may exchange CSI based on the FSK-modulated FMCW communications in accordance with the parameters. Advantages of FSK-modulated FMCW communications and techniques for exchanging signaling to facilitate the FSK-modulated FMCW communications are described in further detail elsewhere herein, including with reference to FIGS. 5-10.

FIG. 5 illustrates an example of an FSK-modulated FMCW configuration 500 that supports CSI reporting for transmissions via FSK-modulated FMCWs in accordance with one or more aspects of the present disclosure. The FSK-modulated FMCW configuration 500 may implement or be implemented by aspects of the wireless communication system 100 and the FSK-modulated FMCW communication scheme 400 described with reference to FIGS. 1 and 4. For example, the FSK-modulated FMCW configuration 500 illustrates an FSK-modulated FMCW chirp that includes one or more frequency shifting periods 520.

The FMCW chirp may correspond to a frequency starting at a starting frequency 525 (e.g., f_{c}) and increasing by a slope 515 across a bandwidth 510. In this aspect, FSK modulation may be applied to the FMCW chirp. The FSK modulation may support multiple data bit rates. The data bit rate may be based on a quantity of frequency shifting periods 520 that are included in one FMCW chirp duration 505. The frequency shifting periods 520 may, in some aspects, be referred to as frequency shifting periods, segments, or portions of an FMCW chirp. The FMCW chirp duration 505 may be divided into a quantity, Nₛ, of frequency shifting periods 520. As illustrated in FIG. 5, the quantity may be one, two, four, eight, or any other quantity of frequency shifting periods 520. In some aspects, an FSK-modulated FMCW may be transmitted via a symbol, such as an OFDM symbol. A first portion of the symbol duration may include a cyclic prefix (CP) 530.

In each frequency shifting period 520, one of the two candidate cosine signals, such as the cosine signals 425 described with reference to FIG. 4 (e.g., {s_{mod,1}(t), s_{mod,2}(t)}), may be selected and applied to the FMCW chirp. The cosine signal may be selected based on one data bit of a data bit stream to be conveyed via the FSK-modulated FMCW in the given frequency shifting period 520. For example, s_{b} may represent one of the cosine signals (e.g., s_{b}=s_{mod,1}(t) or s_{mod,2}(t)) based on a transmitted bit, b, where, b=0~7 is the index of a frequency shifting period 520.

A quantity of bits that is less than or equal to the quantity of frequency shifting periods 520 (e.g., at most Nₛ bits) may be transmitted in one FMCW chirp duration 505. If channel coding is applied, then at most N_{b}≤Nₛ data bits may be transmitted in a single FMCW chirp duration 505. By adjusting values of Nₛ and using different coding rates, the system may attain different data rates. In one aspect, if one FMCW chirp duration 505 is equal to half a millisecond and no channel coding is applied, the data bit rates may be two Kilobytes per second (Kbps), four Kbps, six Kbps, and eight Kbps, for values of Nₛ equal to one, two, four, and eight, respectively, as illustrated in FIG. 5. If there is one frequency shifting period 520-a in a chirp duration 505 (e.g., Nₛ=1), a single cosine signal may be applied to the FMCW chirp. If there are two frequency shifting periods 520-b and 520-c in the FMCW chirp duration 505 (e.g., Nₛ=2), one or both of the candidate cosine signals may be applied to the FMCW chirp. If there are four frequency shifting periods 520-d, 520-e, 520-f, and 520-g in the FMCW chirp duration 505 (e.g., Nₛ=4), any one of the two candidate cosine signals may be applied to the FMCW chirp in each of the four frequency shifting periods 520. If there are eight frequency shifting periods 520-h, 520-i, 520-j, 520-k, 520-1, 520-m, 520-n, and 520-o in the FMCW chirp duration 505 (e.g., Nₛ=8), any one of the two candidate cosine signals may be applied to the FMCW chirp in each of the eight frequency shifting periods 520.

A quantity of frequency shifting periods 520 per FMCW chirp duration 505 may be based on (e.g., restricted by) a channel status. In one aspect, if channel SNR is relatively low, judgment of the selected cosine signal may be relatively difficult. As such, the spreading factor and the duration of a frequency shifting period 520 may be increased to improve throughput and reliability. In one aspect, if an FMCW chirp includes 2^{SF} samples, and if Nₛ>SF, then the data rate of this communication scheme may be higher than FMCW-based LoRA. For example, if SF=8, then 2^{SF}=256, and the whole chirp duration 505 may be divided into Nₛ=16 frequency shifting periods 520, so Nₛ=2×SF.

Accordingly, for FSK-modulated FMCW communications, a single FMCW chirp may be divided into multiple frequency shifting periods 520 belonging to a same FMCW chirp. Each frequency shifting period 520 may be modulated with a respective shifting frequency, which may improve data rates and throughput. A receiving device may perform sensing with a relatively long FMCW chirp duration 505, which may improve sensing performance as compared with FMCW-based LoRa communications.

The FSK-modulated FMCW transmissions described herein may be used for both sensing (e.g., ranging, positioning, detection) and data transmission. Multiple different transmission formats with different data rates may be supported. In some aspects, the transmission format of an FSK-modulated FMCW transmission may be based on one or more parameters, including one or more parameters for communication and one or more parameters for sensing. The one or more parameters for communication may include a quantity of frequency shifting periods Nₛ, a code rate, one or more other parameters, or any combination thereof. The one or more parameters for sensing may include a chirp slope 515 (S), a chirp duration 505 (T_{chirp}), a chirp bandwidth 510, one or more other parameters, or any combination thereof. In some aspects, the parameters for sensing may satisfy.

$$S = \frac{BW}{{T}_{chirp}} .$$

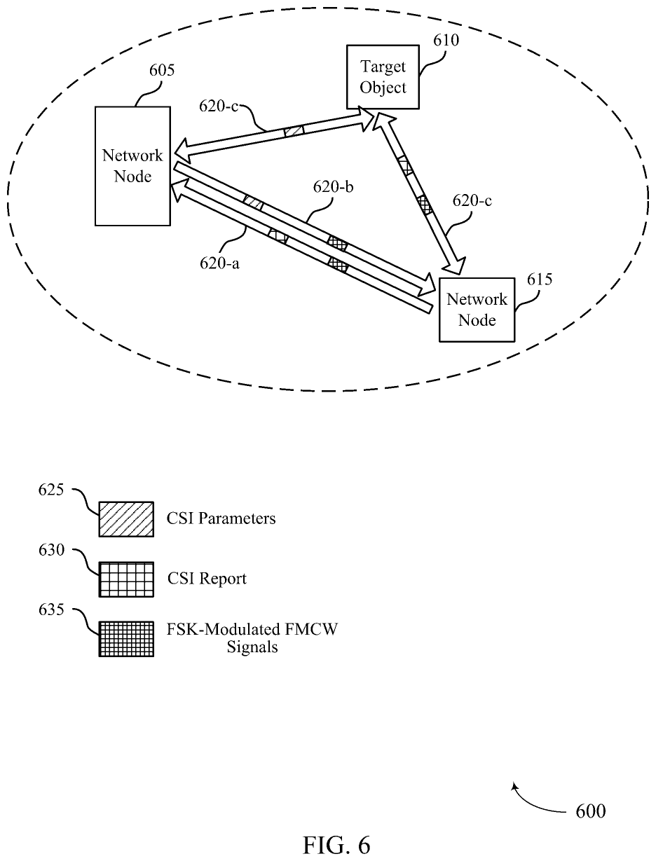

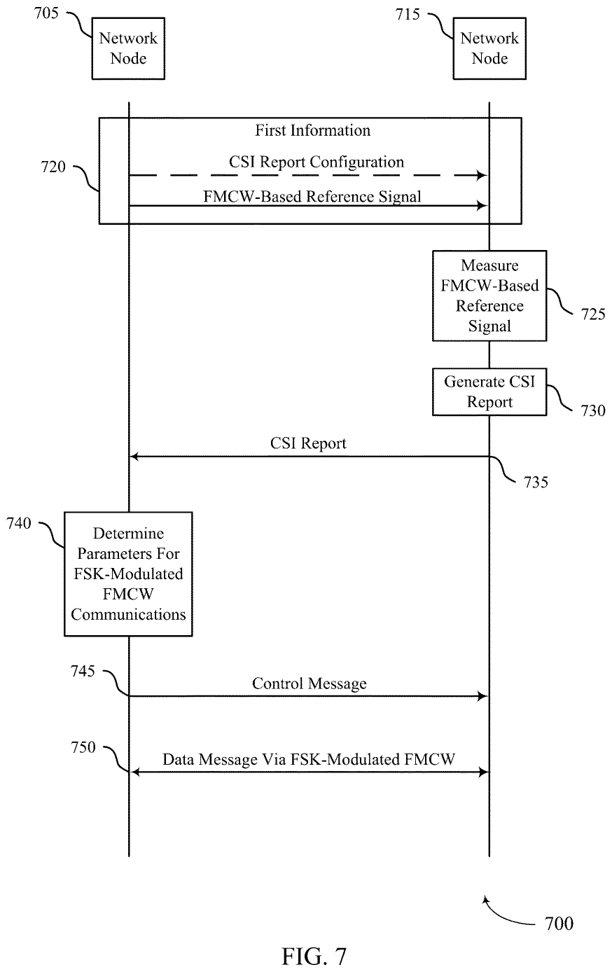

Techniques, systems, and devices described herein provide for wireless communication devices to exchange signaling indicative of the parameters for FSK-modulated FMCW-based sensing and communication. The described techniques may provide for joint optimization of the sensing and communication using FSK-modulated FMCW-based signaling. Techniques for indicating parameters for FSK-modulated FMCW-based sensing and communication are described in further detail elsewhere herein, including with reference to FIGS. 6-7. In some aspects, a quantity of candidate frequency shifting values (e.g., a quantity of cosine signals 425) to be selected from for each frequency shifting period 520 may be increased to greater than two to improve data rate and communication throughput. Techniques for increasing the quantity of candidate frequency shifting values are described in further detail elsewhere herein, including with reference to FIGS. 6-10.

FIG. 6 illustrates an example of a wireless communication system 600 that supports CSI reporting for transmissions via FSK-modulated FMCWs in accordance with one or more aspects of the present disclosure. The wireless communication system 600 may implement or be implemented by aspects of the wireless communication system 100, the FSK-modulated FMCW communication scheme 400, and the FSK-modulated FMCW configuration 500 described with reference to FIGS. 1, 4, and 5. For example, the wireless communication system 600 may include a network node 605 and a network node 615, each of which may represent an example of a wireless communication device, such as a base station, a UE, an RU, a DU, a CU, an IAB node or some other network node, as described with reference to FIGS. 1-5. In this aspect, the network node 605 and the network node 615 may support FSK-modulated FMCW communications for wireless communications and sensing.

The network node 605 and the network node 615 may support sensing and communications using FMCW signals with or without FSK modulation. The sensing may be bistatic or monostatic sensing. To perform monostatic sensing, the network node 605 may transmit an FMCW signal via the communication link 620-b. The FMCW signal may bounce or reflect off of a target object, which, in the example of FIG. 6, may be the network node 615. The network node 605 may receive the reflected FMCW signal via the communication link 620-a and may use measurements of the signal to estimate a distance to the network node 615, a location of the network node 615, a velocity or acceleration of the network node 615, one or more other parameters of the network node 615, or any combination thereof. The network node 615 may similarly perform monostatic sensing by transmitting an FMCW signal via the communication link 620-a and measuring a reflection received via the communication link 620-b.

To perform bistatic sensing, the network node 605 may similarly transmit the FMCW signal to the network node 615, but the FMCW signal may travel via a bistatic communication path 620-c that may reflect off of a target object 610. The network node 615 may receive the FMCW signal via the communication path 620-c and may use measurements of the signal to estimate a distance to the target object 610, a location of the target object 610, a velocity or acceleration of the target object 610, one or more other parameters of the target object 610, or any combination thereof. The network node 615 may similarly transmit an FMCW signal via the bistatic communication path 620-c for the network node 605 to use for sensing and ranging calculations.

The network node 605 and the network node 615 may exchange data via FMCW signals by modulating the data with the FMCW signals using FSK modulation. That is, the network nodes may communicate using FSK-modulated FMCW signals 635. The FSK-modulated FMCW signals 635 may be used for sensing, communications, or both. For example, the network node 605 may transmit an FMCW signal to the network node 615 for sensing, and the network node 605 may FSK modulate data with the FMCW signal and transmit the FSK-modulated FMCW signal 635 to support the sensing and to convey data or other information to the network node 615. As such, FSK modulation may improve efficiency, communication reliability, throughput, and improve efficiency of resource utilization, among other advantages.

In some aspects, the FSK-modulated FMCW signals 635 may be used for communication and bistatic sensing. The FSK-modulated FMCW signal 635 may propagate along the communication path 620-c between the network node 605, the target object 610, and the network node 615. Based on a same FMCW chirp, the network node 605, the network node 615, or both may estimate a position of the target object 610 and the network node 605 may transmit data to the network node 615 based on the FSK modulation applied to the FMCW chirp. In some aspects, the FSK-modulated FMCW signals 635 may be used for communication and device positioning. The FSK-modulated FMCW signal 635 may propagate along the communication link 620-a, or the communication link 620-b, or both between the network node 605 and the network node 615. The network node 605 may estimate a position of the network node 615 (e.g., a UE 115) based on an FMCW chirp and the network node 605 may also transmit data to the network node 605 based on FSK modulation applied to the same FMCW chirp. In some aspects, the FSK-modulated FMCW signals 635 may be used only for communication without sensing based on the FSK modulation with the FMCW. In some other aspects, the network nodes may utilize FMCW signaling (e.g., with or without FSK modulation) to perform sensing without communications.

The network nodes 605 and 615 may support various FMCW-based capabilities based on a type of the network nodes. In some aspects, a first type of network node (e.g., Type 1) may have relatively low FMCW capabilities (e.g., an ADC with a relatively low sampling rate). Such a network node (e.g., an IoT device dedicated for sensing, or another type of device) may support reduced cost by supporting transmission and reception of FMCW chirps but not other types of communication signals (e.g., Wi-Fi, LTE, NB-IoT, or the like). A second type of network node (e.g., Type 2) may support transmission and reception of both FMCW-based signals and other communication signals. In some sensing-related use cases, the second type of network node may switch to a communication mode that supports only FMCW-based transmit and receive functions for power saving, as other communication types may be associated with greater power consumption than FMCW-based communications. In some aspects, there may be two or more sub-types of the second type of network node. A first sub-type (e.g., Type 2-1) may support data channel communications via an FMCW link using FMCW-based signaling and may support control channel communications via an OFDM link using OFDM signals (or some other type of communication signals). A second sub-type (e.g., Type 2-2) may support both control and data channel communications using the FMCW link and FMCW-based signaling.

The network node 605 and the network node 615 may thereby support FSK-modulated FMCW signals 635 for sensing and communication. In some aspects, if the network node 605 and the network node 615 do not exchange signaling to facilitate the FSK-modulated FMCW communications, the network nodes may not know parameters for the FSK-modulated FMCW signals 635, may not know whether the FSK-modulated FMCW signals 635 are being used for sensing or communications, or both, which may reduce throughput and communication reliability.

Techniques, systems, and devices described herein provide for the network node 605 and the network node 615 to exchange signaling to indicate parameters for FSK-modulated FMCW communications (e.g., a quantity or duration of frequency shift periods, a code rate, a bandwidth, an FMCW slope, an FMCW chirp duration, and other parameters), which may improve throughput and communication reliability. The network nodes 605 and 615 may exchange CSI (e.g., the CSI report 630) based on the FSK-modulated FMCW communications in accordance with the parameters. In order for the network node 615 to measure and determine CSI of FMCW communications, the network node 615 may first be configured with CSI parameters 625 for the CSI measurement. To this end, the network node 605 may transmit, to the network node 615, information that indicates the CSI parameters 625 for measuring CSI and generating a CSI report 630 associated with an FMCW communication type. The information may be conveyed via an FSK-modulated FMCW-based CSI reference signal (CSI-RS) or via another message separate from the FMCW-based CSI-RS (e.g., via the communication link 620-b or the communication link 620-c).

The network node 615 may measure the FMCW-based CSI-RS and may generate a CSI report 630 that includes parameters determined by the network node 615 for subsequent FSK-modulated FMCW communications based on measurement information associated with the FMCW-based CSI-RS. The CSI report 630 may be associated with an FMCW communication type based on the CSI report 630 being generated based on the measurement information associated with the FMCW-based CSI-RS. The network node 615 may transmit the CSI report 630 to the network node 605 (e.g., via the communication link 620-a or the communication link 620-c). Subsequent communications (e.g., the FSK-modulated FMCW signals 635) between the network node 605 and the network node 615 may be based on the indicated parameters. The parameters may include one or more of a quantity of frequency shifting periods, a frequency shifting interval (e.g., a quantity of bits per frequency shifting period), and a code rate. The initial CSI configuration, the CSI report 630, or both may be communicated via FSK-modulated FMCW-based signals or other signals (e.g., OFDM transmissions) based on a capability of the network node 615 to transmit and receive FMCW-based signals or both FMCW-based signals and other communication signals.

Although the signals are shown as being exchanged via the communication links 620-a and 620-b in FIG. 6, it is to be understood that, in some aspects, the network node 605 and the network node 615 may exchange the CSI parameters 625, the CSI report 630, and the other FSK-modulated FMCW signals 635 via the communication link 620-c (e.g., a bistatic path that reflects off of a target object 610), or some other communication link or path not pictured in FIG. 6. The network nodes 605 and 615 may thereby exchange signaling to facilitate reliable and efficient communications, sensing, or both using FSK-modulated FMCW signals 635. The FSK-modulated FMCW signals 635 may include signals that convey uplink or downlink data, uplink or downlink control information, sensing information, positioning information, or any combination thereof. By utilizing the FSK-modulated FMCW signals 635 for both sensing and communication, the network nodes may support more efficient utilization of communication resources.

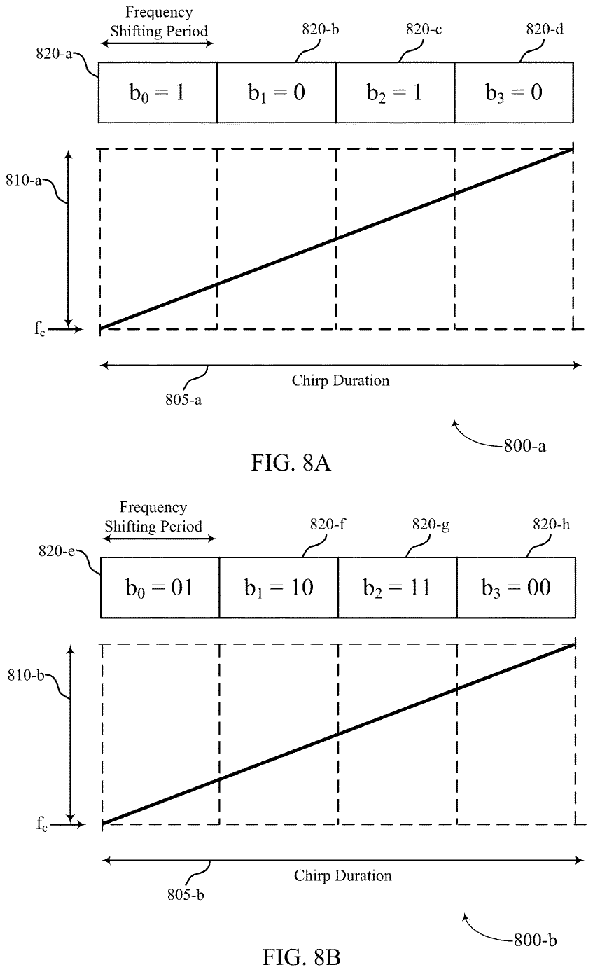

In some aspects described herein, the network node 605, the network node 615, or both may use more than two candidate frequencies for the FSK modulation. For example, when generating an FSK-modulated FMCW signal 635, a transmitting network node may select from three or more candidate frequencies based on a value of a data bit stream to be conveyed via the FSK-modulated FMCW signal 635. The transmitting network node may apply a sinusoidal function associated with the selected frequency to the FMCW signal per frequency shifting period. The quantity of candidate frequencies may be based on a frequency shifting interval and a bandwidth of the signal. By increasing the quantity of candidate frequencies, the network nodes 605 and 615 may support increased data rate and communication throughput. Techniques for using three or more candidate frequency shifting values are described in further detail elsewhere herein, including with reference to FIGS. 8-10.

FIG. 7 illustrates an example of a process flow 700 that supports CSI reporting for transmissions via FSK-modulated FMCWs in accordance with one or more aspects of the present disclosure. The process flow 700 may implement or be implemented by aspects of the wireless communication systems 100 and 600, the FSK-modulated FMCW communication scheme 400, and the FSK-modulated FMCW configuration 500, as described with reference to FIGS. 1 and 4-6. For example, the process flow 700 illustrates communications between a network node 705 and a network node 715, which may represent aspects of corresponding devices as described with reference to FIGS. 1-6. In some aspects, the network nodes 1005 and 1015 may exchange signaling to facilitate FSK-modulated FMCW signals for sensing and communications.

In the following description of the process flow 700, the operations between the network node 705 and the network node 715 may be performed in different orders or at different times. Some operations may also be left out of the process flow 700, or other operations may be added. Although the network node 705 and the network node 715 are shown performing the operations of the process flow 700, some aspects of some operations may also be performed by one or more other wireless devices.

At 720, the network node 705 may transmit, to the network node 715, first information that indicates a first set of parameters for generation of a CSI report associated with an FMCW communication type (e.g., based on measurement information corresponding to one or more FMCW-based signals). The first information may be transmitted via a CSI report configuration (e.g., Message 1). In some aspects, the CSI report configuration may be transmitted together with or separated from an FMCW-based reference signal (e.g., a CSI-RS). That is, the network node 705 may transmit an FMCW-based reference signal to the network node 715, and the CSI report configuration may be transmitted as a separate message or may be conveyed via the FMCW-based reference signal based on FSK-modulation.

If the CSI report configuration is transmitted separately from the FMCW-based reference signal, the CSI report configuration may be transmitted in a message conveyed via a communication link (e.g., an NB-IoT link, LTE link, NR link, Wi-Fi link, or other types of communication links). In this aspect, the CSI report configuration may indicate the first set of parameters for generating the CSI report and may indicate a second set of parameters for transmission formats of the FMCW-based reference signal, which may be subsequently transmitted in accordance with the indicated transmission formats. The network node 705 may transmit the CSI report configuration separate from the FMCW-based reference signal if, for example, the network node 715 supports both FMCW-based communications and other types of communication signals (e.g., a Type 2 device, as described with reference to FIG. 6).

If the CSI report configuration is transmitted together with the FMCW-based reference signal, the first information including the first set of parameters may be modulated with the FMCW-based reference signal using FSK modulation, as described in further detail elsewhere herein, including with reference to FIGS. 4 and 5. In this aspect, one or more initial parameters for transmission and reception of the FSK-modulated FMCW reference signal may be configured (e.g., regulated, standardized, or pre-configured). In some aspects, to reduce impact of the CSI report configuration data that is modulated with the reference signal on channel status measurements that are based on the reference signal, the network node 705 may select a frequency shifting interval (Iₛ) that is greater than a product of a slope(S) of the FMCW signal and a maximum possible path delay (τ_{max,0}) (e.g., Iₛ>Sτ_{max,0}). The maximum path delay may, in some aspects, be previously configured or known by the network node 705.

The first information may indicate a first set of parameters for generation of a CSI report associated with an FMCW signal. The first set of parameters may include one or more first parameters for communication, one or more second parameters for sensing, one or more other parameters, or any combination thereof. The first parameters for communication may include a set ( [symbol] ) of candidate values for a quantity of frequency shifting periods (Nₛ) in a single FMCW chirp duration, a set ( [symbol] ) of candidate code rates, other FSK-modulated FMCW communication parameters, or any combination thereof. The second parameters for sensing may include a set ( [symbol] ) of candidate values for frequency shifting intervals in a single frequency shifting period, or other parameters for FMCW communications, or any combination thereof. One or more other parameters in the first set of parameters may include a CSI-RS report type (e.g., periodic, semi-persistent, aperiodic), a quantity of symbols per FMCW chirp duration, a duration of an FMCW chirp, a bandwidth of an FMCW signal, or any combination thereof. In some aspects, the first information may indicate a set ( [symbol] ) of a frequency pair of candidate FSK signals (e.g., (f_{FSK,1} and f_{FSK,2}).

At 725, the network node 715 may measure the FMCW-based reference signal and may determine a second set of parameters for FSK-modulated FMCW communications between the network node 715 and the network node 705. Measuring the FMCW-based reference signal may include measuring a channel status, one or more channel parameters, one or more signal metrics, or any combination thereof. In some aspects, the network node 715 may determine or estimate an SNR of the FMCW-based reference signal based on measurements of the FMCW-based reference signal (e.g., an SNR of the FMCW processing output signal, D_{Rx}(k), as described with reference to FIGS. 2A and 2B). The network node 715 may select a quantity of frequency shifting periods, Nₛ, from the set, [symbol] , of candidate quantities indicated via the first information, based on the SNR. As SNR of the signal increases, a time for distinguishing candidate cosine signals from the FMCW processing output signal may decrease, which may provide for larger quantities of frequency shifting periods to be supported. A maximum quantity of frequency shifting periods may be less than or equal to a maximum value in the set of candidate values indicated via the first information (e.g., Nₛ∈ [symbol] ) and may be based on regulations for distinguishing candidate cosine signals (e.g., {s_{mod,m}(t)}).

In some aspects, as part of measuring the FMCW-based reference signal and determining the second set of parameters, the network node 715 may estimate a maximum path delay, τₘₐₓ, based on the FMCW-based reference signal (e.g., CSI-RS). The network node 715 may select a frequency shifting interval, Iₛ, from the set, [symbol] , of candidate frequency shifting intervals indicated via the first information based on the maximum path delay. For example, the selected frequency shifting interval may be greater than a product of a slope of the FMCW and the maximum path delay (e.g., Iₛ>S·τₘₐₓ and Iₛ ∈ [symbol] ). The frequency shifting interval may be related to a quantity of data bits that may be transmitted via a single frequency shifting period, as described in further detail elsewhere herein, including with reference to FIGS. 8-10. In some aspects, the network node 715 may determine frequencies of the FSK candidate cosine signals (e.g., f_{FSK,1} and f_{FSK,2}).

If channel coding is applied, the network node 715 may determine, as part of measuring the FMCW-based reference signal and determining the second set of parameters, a code rate, r_{code}, for subsequent FSK-modulated FMCW communications based on the determined quantity of frequency shifting periods, the determined frequency shifting interval value, and the SNR. The code rate may be selected from the set of candidate code rates indicated via the first information (e.g., r_{code} ∈ [symbol] ).

At 730, the network node 715 may generate a CSI report based on the first set of parameters and based on measurement information corresponding to the FMCW-based reference signal. The CSI report may include the second set of parameters for the subsequent FSK-modulated FMCW communications between the network node 715 and the network node 705. In one aspect, the CSI report may include the quantity of frequency shifting periods, the frequency shifting interval value, the candidate frequency shifting values, and the code rate determined by the network node 715 at 725 (e.g., Nₛ, Iₛ, f_{FSK,1} and f_{FSK,2}, and r_{code}).

At 735, the network node 715 may transmit the CSI report to the network node 705 to indicate the second set of parameters for FSK-modulated FMCW communications. The network node 715 may transmit the CSI report to the network node 705 before the FSK-modulated FMCW communications between the network node 705 and the network node 715. The CSI report may indicate the quantity of frequency shifting periods, the frequency shifting interval in one frequency shifting period, the code rate, or any combination thereof determined by the network node 715 for subsequent FSK-modulated FMCW communications. In some aspects, the CSI report message may be carried via FSK modulation on an FMCW signal (e.g., for devices that support FMCW communications, such as Type 1 and Type 2 devices, as described with reference to FIG. 6). The CSI report message may be FSK modulated with an FMCW-based sounding reference signal (SRS) transmitted by the network node 715. In such cases, the transmission format parameters for generating and transmitting the FSK-modulated FMCW-based SRS may be configured (e.g., regulated by a standard) or indicated via the first information. In some other aspects, the CSI report message may be transmitted via other types of signaling different than FMCW-based signaling, such as via an OFDM channel (e.g., for devices that support other types of communications, such as a Type 2 device, as described with reference to FIG. 6). If the network node 715 transmits the CSI report via non-FMCW signaling, the network node 715 may or may not transmit the FMCW-based SRS. In some aspects, the network node 715 may transmit the CSI report for the FSK-modulated FMCW-based communications together with or separate from a CSI report for OFDM communications.

At 740, the network node 705 may determine a third set of parameters for subsequent FSK-modulated FMCW communications between the network node 705 and the network node 715. The network node 705 may determine the third set of parameters based on the second set of parameters indicated via the CSI report. In some aspects, the third set of parameters may be the same as the second set of parameters. Additionally, or alternatively, the second set of parameters may be a suggested set of parameters, and the third set of parameters determined by the network node may be different than the second set of parameters (e.g., may include at least one adjusted parameter).

At 745, the network node 705 may transmit a control message to the network node 715. The control message may indicate a data transmission grant for FSK-modulation with FMCW and may include second information that indicates the third set of parameters for the subsequent FSK-modulated FMCW communications between the network node 715 and the network node 705. In some aspects, the network node 705 may FSK modulate control information that indicates the third set of parameters with an FMCW signal (e.g., for devices that support FMCW communications, such as Type 1 and Type 2 devices, as described with reference to FIG. 6). The control message may be an FSK-modulated FMCW control message (e.g., similar to a physical downlink control channel (PDCCH)). If the control message is transmitted via an FSK-modulated FMCW signal, transmission format parameters for FSK and FMCW may be configured (e.g., regulated by a standard) or indicated via the first information. In one aspect, the transmission format parameters for FSK and FMCW control signaling may include a quantity of frequency shifting periods for control signaling, a frequency shifting interval for control signaling, a code rate for control signaling, or any combination thereof

$$( e . g . , {N}_{s}^{PDCCH} , {I}_{s}^{PDCCH} and / or {r}_{code}^{PDCCH} ) .$$

In some aspects, the network node 705 may transmit the control message via a communication link different than an FMCW communication link, such as an OFDM channel. That is, the third set of parameters may not be FSK modulated with an FMCW signal.

At 750, the network node 705 and the network node 715 may exchange one or more data messages via FSK-modulated FMCW signals. The network nodes may FSK modulate data on the FMCW signals. That is, the network node 705 and the network node 715 may perform FSK-modulated FMCW communications. The data messages may be transmitted and received in accordance with the third set of parameters indicated via the control message. In some aspects, if the network node 705 does not determine the third set of parameters or does not transmit the control message, the data messages may be transmitted and received in accordance with the second set of parameters indicated via the CSI report.

Any one or more of the FMCW-based signals exchanged between the network node 705 and the network node 715 may be used as sensing signals for localizing a network node or sensing target object, as described in further detail elsewhere herein, including with reference to FIGS. 2-6. As such, the network node 705 or the network node 715 may transmit an FMCW-based sensing signal that may additionally carry data based on FSK modulation applied to the FMCW-based sensing signal, which may improve throughput. In some aspects, the FSK modulated data may be used to indicate an ID of one network node or a set of two or more network nodes (e.g., UEs 115 or other types of network nodes) that are intended for reception of the FMCW-based sensing signal, which may reduce resource utilization, as a second communication link for indicating the IDs may not be needed.

The network node 705 and the network node 715 may thereby exchange signaling to determine parameters for communications using FSK-modulated FMCW signals. By determining the FSK parameters in accordance with the techniques described herein, the network nodes may support improved communication reliability and throughput and maintain compliance with different wireless communication guidelines (e.g., ISAC, or other wireless communication guidelines) while using FMCW-based signaling to reduce power consumption.

FIGS. 8A and 8B illustrate examples of FSK-modulated FMCW configurations 800-a and 800-b that support CSI reporting for transmissions via FSK-modulated FMCWs in accordance with one or more aspects of the present disclosure. The FSK-modulated FMCW configurations 800 may implement or be implemented by aspects of the wireless communication systems 100 and 600, the FSK-modulated FMCW communication scheme 400, the FSK-modulated FMCW configuration 500, and the process flow 700 described with reference to FIGS. 1-7. For example, the FSK-modulated FMCW configuration 800-a illustrates an FMCW chirp that is FSK modulated using two candidate frequency shifting values across multiple frequency shifting periods 820 and the FSK-modulated FMCW configuration 800-b illustrates an FMCW chirp that is FSK modulated using three or more candidate frequency shifting values across multiple frequency shifting periods 820.

FIG. 8A illustrates an example of an FSK-modulated FMCW configuration 800-a. The FSK-modulated FMCW configuration 800-a may represent an example of the FSK-modulated FMCW configuration 500 described with reference to FIG. 5. For example, the FSK-modulated FMCW configuration 800-a illustrates an FMCW chirp that increases in frequency in accordance with a constant slope across a bandwidth 810-a (e.g., starting at a starting frequency f_{c}) and over a chirp duration 805-a. Although not illustrated in FIG. 8A, it is to be understood that the FMCW chirp duration 805-a may correspond to a symbol duration and may be appended to a cyclic prefix, in some aspects. The FMCW chirp duration 805-a may be divided into four frequency shifting periods 820-a, 820-b, 820-c, and 820-d (e.g., Nₛ=4).

The FMCW chirp may be FSK-modulated by applying or modulating a cosine signal with a given carrier frequency to the FMCW chirp during each frequency shifting period 820. The cosine signal may be selected from a set of two candidate cosine signals (e.g., {s_{mod,1}(t), s_{mod,2}(t)}) based on a value of a data bit in a data bit stream to be conveyed via the FSK modulation, as described with reference to FIG. 5. The frequency shifting is thereby generated by a cosine signal, which may make both positive and negative frequency shifts. Accordingly, a single bit may be conveyed via each frequency shifting period 820. In the example illustrated in FIG. 8A, bits b₀ and b₂ may be high (e.g., one) in frequency shifting periods 820-a and 820-c, respectively, and bits b₁ and b₂ may be low (e.g., zero) in frequency shifting periods 820-b and 820-d, respectively, based on the selected cosine signals in the respective frequency shifting periods 820.

FIG. 8B illustrates an example FSK-modulated FMCW configuration 800-b when FSK is applied using a set of three or more candidate frequency shifting values. The FMCW chirp illustrated in FIG. 8B may be associated with an increasing frequency in accordance with a constant slope over a bandwidth 810-b and a chirp duration 805-b. The FMCW chirp duration 805-b may be divided into four frequency shifting periods 820-e, 820-f, 820-g, and 820-h, similar to the frequency shifting periods 820 described with reference to FIG. 8A.

In this aspect, the FMCW signal may be modulated in each frequency shifting period 820 using a respective frequency shifting value that is selected from a set of three or more candidate frequency shifting values. That is, in one frequency shifting period 820, a respective frequency shifting value may be selected from a quantity, N_{b}, of multiple candidate frequency shifting values corresponding to multiple cosine signal carrier frequencies (e.g., f_{mod,1}~f_{mod,N}_{_{b}}₋₁). In some aspects, if more than two candidate frequency shifting values are used, the frequency shifting for FSK modulation may be generated by a relatively complex exponential signal instead of a cosine signal. The exponential signal may make positive frequency shifts instead of negative frequency shifts, which may increase data rate.

A quantity of data bits that may be transmitted may be based on the quantity of candidate frequency shifting values. The quantity of candidate frequency shifting values (e.g., a value of N_{b}) may be based on a frequency shifting interval, Iₛ, for the FSK-modulated FMCW communications. The frequency shifting interval may be configured or indicated via one or more of a CSI report or a control message, as described with reference to FIG. 7. In some aspects, the frequency shifting interval may be based on or configured for a type of transmission, such as an uplink frequency shifting interval, a downlink frequency shifting interval, or a control channel frequency shifting interval

$$( e . g . , {I}_{s}^{PDSCH} , {I}_{s}^{PUSCH} , or {I}_{s}^{PDCCH} ) .$$

In one aspect, the quantity of candidate frequency shifting values may be based on a quotient of the bandwidth 810-b and the frequency shifting interval

$$( e . g . , {N}_{b} = ⌊ \frac{BW}{2 {I}_{s}^{PDSCH}} ⌋ or ⌊ \frac{BW}{2 {I}_{s}^{PUSCH}} ⌋ ) .$$

In some aspects, ┌log₂ N_{b}┐ data bits may be transmitted per frequency shifting period 820. If an impact of spreading factor is considered, a quantity of data bits transmitted per frequency shifting period 820 may be determined according to Equation 12.

$$min ( ⌊ {log}_{2} {N}_{b} ⌋ , ⌊ {log}_{2} \frac{{2}^{SF}}{{N}_{s}} ⌋ ) \qquad ( 12 )$$

A quantity of data bits in a single FMCW chirp (e.g., in the FMCW chirp duration 805-b) may be equal to a product of the quantity of bits per frequency shifting period 820 in Equation 12 and the quantity of frequency shifting periods, Nₛ.

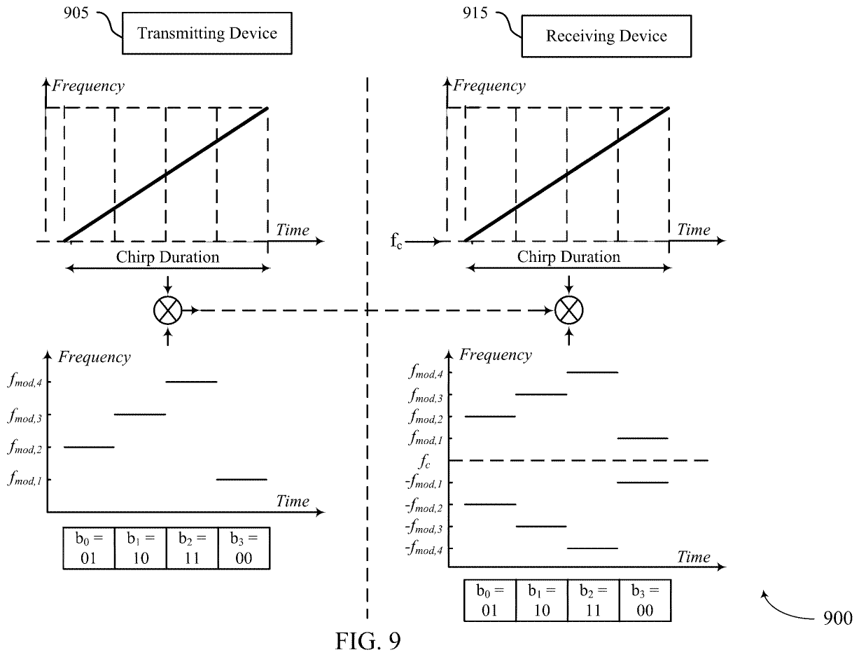

As illustrated in FIG. 8B, there may be four candidate frequency shift values per frequency shifting period 820, and two data bits may be conveyed via each frequency shifting period 820 accordingly. By using a set of three or more candidate frequency shifting values, a transmitting network node may support improved data rate and throughput. The modulation and demodulation of the FMCW chirp using the selected frequency shifting value is illustrated and described in further detail with reference to FIG. 9.

FIG. 9 illustrates an example of an FMCW-based FSK modulation and demodulation scheme 900 that supports CSI reporting for transmissions via FSK-modulated FMCWs in accordance with one or more aspects of the present disclosure. The FMCW-based FSK modulation and demodulation scheme 900 may implement or be implemented by aspects of the FSK-modulated FMCW configuration 800-b described with reference to FIG. 8B. For example, the FMCW-based FSK modulation and demodulation scheme 900 illustrates data modulation by a transmitting device 905 and data demodulation by a receiving device 915 of an FMCW-based FSK signal when four candidate frequency shifting values are used. The transmitting device 905 and the receiving device 915 may each represent an example of a base station, a UE, an RU, a DU, a CU, an IAB node or some other network node, as described with reference to FIGS. 1-8.

The transmitting device 905 may modulate a data stream into an FMCW using FSK modulation and may transmit the FSK-modulated FMCW signal to the receiving device 915. The FMCW may include four frequency shifting periods, and the transmitting device 905 may select a frequency shifting value from among a set of two or more frequency shifting values (four in the example illustrated in FIG. 9) to apply to (e.g., modulate) the FMCW during each frequency shifting interval. The selected frequency shifting value may be based on a bit in the data stream. For example, for each frequency shifting period, one in

$${\{ {s}_{mod , m} \}}_{m = 1}^{4}$$

frequency shifting values may be selected based on the data bit. As illustrated in FIG. 9, the transmitting device 905 may modulate the FMCW with a first frequency shifting value (f_{mod,2}) during a first frequency shifting period, a second frequency shifting value (f_{mod,3}) during a second frequency shifting period, a third frequency shifting value (f_{mod,4}) during a third frequency shifting period, and a fourth frequency shifting value (f_{mod,1}) during a fourth frequency shifting period.

As described with reference to FIG. 8B, because there are four candidate frequency shifting values, two bits may be conveyed via each frequency shifting period. The transmitting device 905 may transmit the FSK-modulated FMCW signal to the receiving device 915. The FSK-modulated FMCW signal may convey data for sensing, communications, or both, as described herein.

The receiving device 915 may receive and demodulate the FSK-modulated FMCW signal. In some aspects, the receiving device 915 may view an FMCW modulated with positive and negative frequency shift values, which may be reflected around a central frequency, f_{c}, in the frequency domain, as illustrated in FIG. 9. In some aspects, the receiving device 915 may retrieve or demodulate two data bits conveyed via each frequency shift period of the FMCW based on a judgment of which frequency shift value of the four candidate frequency shift values

$$( e . g . , which one of {\{ {s}_{mod , m} \}}_{m = 1}^{4} )$$

is used for the frequency shift period.

The transmitting device 905 and the receiving device 915 may thereby exchange FSK-modulated FMCW signals that are modulated using a set of three or more candidate frequency shifting values. By selecting frequency shifting values from the set of three or more candidate frequency shifting values, the transmitting device 905 may increase data rate and throughput while maintaining communication reliability.

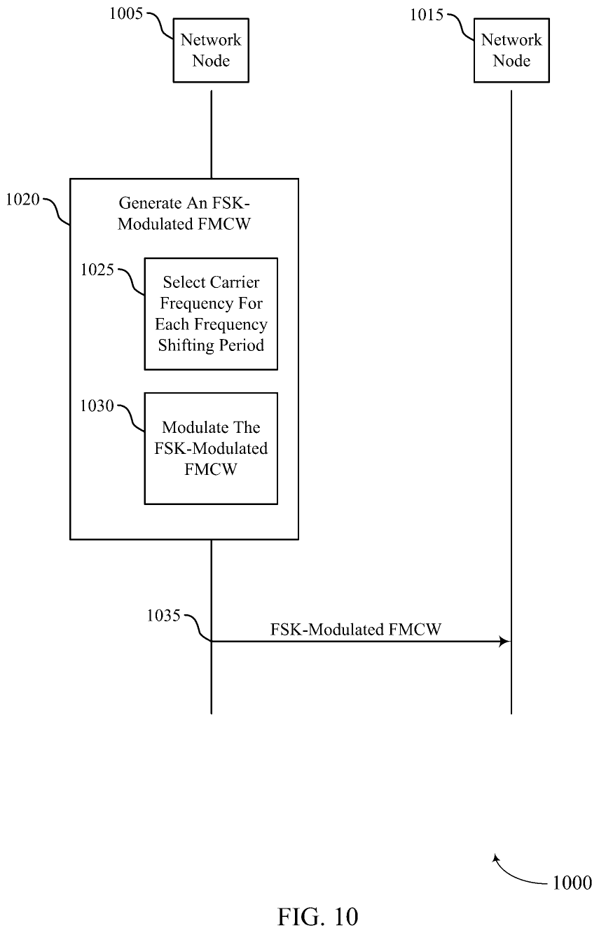

FIG. 10 illustrates an example of a process flow 1000 that supports CSI reporting for transmissions via FSK-modulated FMCWs in accordance with one or more aspects of the present disclosure. The process flow 1000 may implement or be implemented by aspects of the wireless communication systems 100 and 600, the FSK-modulated FMCW communication scheme 400, the FSK-modulated FMCW configurations 500 and 800, and the FMCW-based FSK modulation and demodulation scheme 900, as described with reference to FIGS. 1 and 4-9. For example, the process flow 1000 illustrates communications between a network node 1005 and a network node 1015, which may represent aspects of corresponding devices as described with reference to FIGS. 1-9. In some aspects, the network node 1005 and the network node 1015 may support FSK-modulated FMCW signaling, where the FMCW may be modulated, during each frequency shifting period, using a frequency shifting value selected from a set of three or more candidate frequency shifting values.

In the following description of the process flow 1000, the operations between the network node 1005 and the network node 1015 may be performed in different orders or at different times. Some operations may also be left out of the process flow 1000, or other operations may be added. Although the network node 1005 and the network node 1015 are shown performing the operations of the process flow 1000, some aspects of some operations may also be performed by one or more other wireless devices.

At 1020, the network node 1005 may generate an FSK-modulated FMCW to convey a stream of data bits. The stream of data bits may include information for sensing or positioning schemes, or the stream of data bits may include information for communications to the network node 1015, or both. In some aspects, the FSK-modulated FMCW may represent an example of the FSK-modulated FMCW described with reference to FIGS. 8B and 9.

As part of generating the FSK-modulated FMCW, at 1025, the network node 1005 may select a carrier frequency to apply to the FMCW during each frequency shifting period. As described herein, the network node 1005 may select the carrier frequency, which may be referred to as a frequency shifting value in some aspects, from among a set of three or more candidate carrier frequencies (e.g., three, four, five, or some other quantity of candidate carrier frequencies). A quantity of candidate carrier frequencies in the set may be based on a frequency shifting interval of the FMCW and a bandwidth of the FMCW

$$( e . g . , {N}_{b} = ⌊ \frac{BW}{2 {I}_{s}^{PDSCH}} ⌋ or ⌊ \frac{BW}{2 {I}_{s}^{PUSCH}} ⌋ ) ,$$

as described with reference to FIG. 8B. The network node 1005 may select the carrier frequency for a given frequency shifting period based on a value of a subset of one or more data bits that are to be conveyed via the respective frequency shifting period. Each carrier frequency may correspond to a respective sinusoidal and/or complex exponential function, as described with reference to FIGS. 1-9.

As part of generating the FSK-modulated FMCW, at 1030, the network node 1005 may modulate the FSK-modulated FMCW using the respective sinusoidal functions associated with the selected carrier frequencies. That is, the network node 1005 may modulate an FMCW in each frequency shifting period using a respective selected carrier frequency selected for the period, as described in further detail with reference to FIGS. 8 and 9. After modulating the FMCW using FSK modulation and the selected carrier frequencies, the FSK-modulated FMCW signal may be generated and may convey the stream of data bits. In some aspects, the network node 1005 may receive signaling that indicates one or more parameters for generating the FSK-modulated FMCW, as described with reference to FIGS. 6 and 7.

At 1035, the network node 1005 may transmit the FSK-modulated FMCW that conveys the stream of data bits to the network node 1015. The network node 1015 may receive the FSK-modulated FMCW and demodulate the FSK-modulated FMCW to obtain the stream of data bits, as described with reference to FIG. 9. A quantity of data bits that are conveyed via each frequency shifting period of the FSK-modulated FMCW may be based on a spreading factor of the FSK-modulated FMCW, a quantity of the candidate carrier frequencies, and a quantity of frequency shifting periods of the FSK-modulated FMCW. By increasing the quantity of candidate carrier frequencies from which the network node 1005 selects a carrier frequency, the data rate may increase, which may increase throughput, efficiency, and communication reliability while reducing resource utilization.

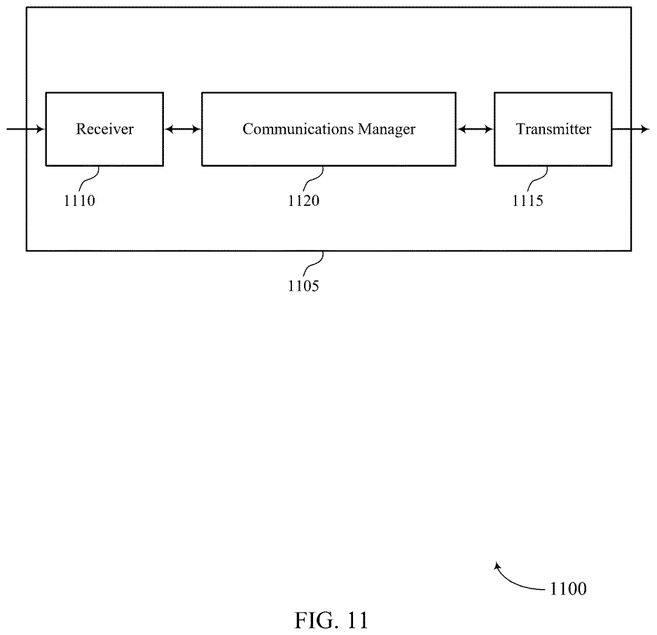

FIG. 11 illustrates a block diagram 1100 of a device 1105 that supports CSI reporting for transmissions via FSK-modulated FMCWs in accordance with one or more aspects of the present disclosure. The device 1105 may be an example of aspects of a UE 115 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CSI reporting for transmissions via FSK-modulated FMCWs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CSI reporting for transmissions via FSK-modulated FMCWs). In some aspects, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of CSI reporting for transmissions via FSK-modulated FMCWs as described herein. For example, the communications manager 1120, the receiver 1110, the transmitter 1115, or various combinations or components thereof may support a method for performing one or more of the functions described herein.

In some aspects, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first network node in accordance with examples as disclosed herein. For example, the communications manager 1120 may be configured as or otherwise support a means for receiving first information that indicates a first set of parameters for generation of a CSI report associated with a FMCW communication type. The communications manager 1120 may be configured as or otherwise support a means for generating, based on the first set of parameters and based on measurement information corresponding to an FMCW-based reference signal, the CSI report, the CSI report including a second set of parameters for FSK-modulated FMCW communications between the first network node and a second network node. The communications manager 1120 may be configured as or otherwise support a means for transmitting, before the FSK-modulated FMCW communications between the first network node and the second network node, the CSI report to the second network node.

Additionally, or alternatively, the communications manager 1120 may support wireless communication at a first network node in accordance with examples as disclosed herein. For example, the communications manager 1120 may be configured as or otherwise support a means for transmitting first information that indicates a first set of parameters for generation of a CSI report associated with a FMCW communication type. The communications manager 1120 may be configured as or otherwise support a means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Additionally, or alternatively, the communications manager 1120 may support wireless communication at a first network node in accordance with examples as disclosed herein. For example, the communications manager 1120 may be configured as or otherwise support a means for generating a FSK-modulated FMCW to convey a stream of data bits. In some aspects, to generate the FSK-modulated FMCW, the communications manager 1120 may be configured as or otherwise support a means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. In some aspects, to generate the FSK-modulated FMCW, the communications manager 1120 may be configured as or otherwise support a means for modulating the FSK-modulated FMCW using respective sinusoidal functions associated with the selected carrier frequencies. The communications manager 1120 may be configured as or otherwise support a means for transmitting the FSK-modulated FMCW that conveys the stream of data bits.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, and more efficient utilization of communication resources.

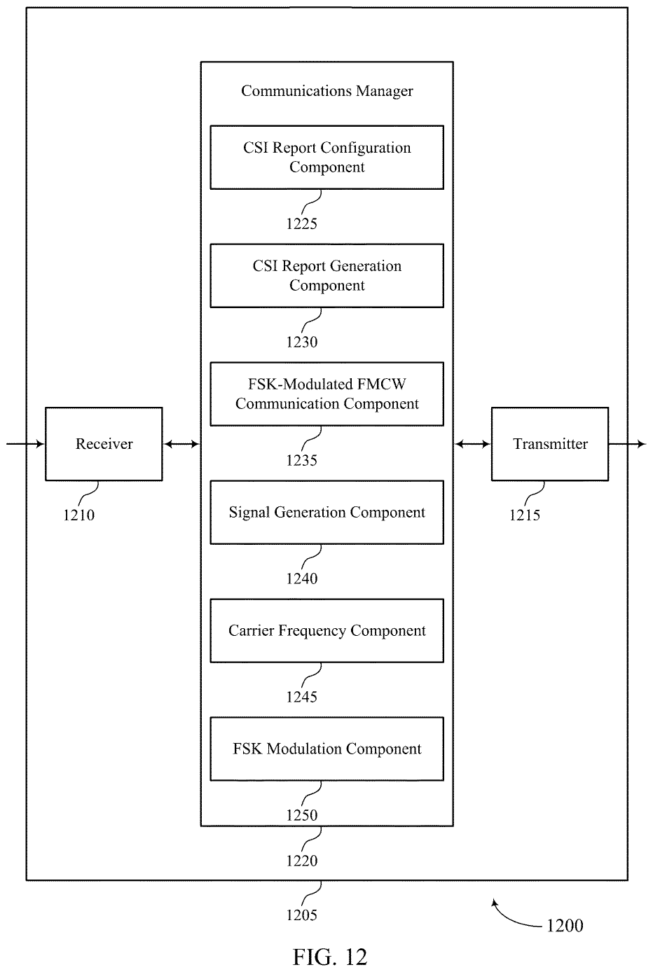

FIG. 12 illustrates a block diagram 1200 of a device 1205 that supports CSI reporting for transmissions via FSK-modulated FMCWs in accordance with one or more aspects of the present disclosure. The device 1205 may be an example of aspects of a device 1105, a UE 115, or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to CSI reporting for transmissions via FSK-modulated FMCWs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to CSI reporting for transmissions via FSK-modulated FMCWs). In some aspects, the transmitter 1215 may be co-located with a receiver 1210 in a transceiver module. The transmitter 1215 may utilize a single antenna or a set of multiple antennas.

The device 1205, or various components thereof, may be an example of means for performing various aspects of CSI reporting for transmissions via FSK-modulated FMCWs as described herein. For example, the communications manager 1220 may include a CSI report configuration component 1225, a CSI report generation component 1230, an FSK-modulated FMCW communication component 1235, a signal generation component 1240, a carrier frequency component 1245, an FSK modulation component 1250, or any combination thereof. The communications manager 1220 may be an example of aspects of a communications manager 1120 as described herein. In some aspects, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a first network node in accordance with examples as disclosed herein. The CSI report configuration component 1225 may be configured as or otherwise support a means for receiving first information that indicates a first set of parameters for generation of a CSI report associated with a FMCW communication type. The CSI report generation component 1230 may be configured as or otherwise support a means for generating, based on the first set of parameters and based on measurement information corresponding to an FMCW-based reference signal, the CSI report, the CSI report including a second set of parameters for FSK-modulated FMCW communications between the first network node and a second network node. The CSI report generation component 1230 may be configured as or otherwise support a means for transmitting, before the FSK-modulated FMCW communications between the first network node and the second network node, the CSI report to the second network node.

Additionally, or alternatively, the communications manager 1220 may support wireless communication at a first network node in accordance with examples as disclosed herein. The CSI report configuration component 1225 may be configured as or otherwise support a means for transmitting first information that indicates a first set of parameters for generation of a CSI report associated with a FMCW communication type. The FSK-modulated FMCW communication component 1235 may be configured as or otherwise support a means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Additionally, or alternatively, the communications manager 1220 may support wireless communication at a first network node in accordance with examples as disclosed herein. The signal generation component 1240 may be configured as or otherwise support a means for generating a FSK-modulated FMCW to convey a stream of data bits. In some aspects, to generate the FSK-modulated FMCW, the carrier frequency component 1245 may be configured as or otherwise support a means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. In some aspects, to generate the FSK-modulated FMCW, the FSK modulation component 1250 may be configured as or otherwise support a means for modulating the FSK-modulated FMCW using respective sinusoidal functions associated with the selected carrier frequencies. The FSK-modulated FMCW communication component 1235 may be configured as or otherwise support a means for transmitting the FSK-modulated FMCW that conveys the stream of data bits.

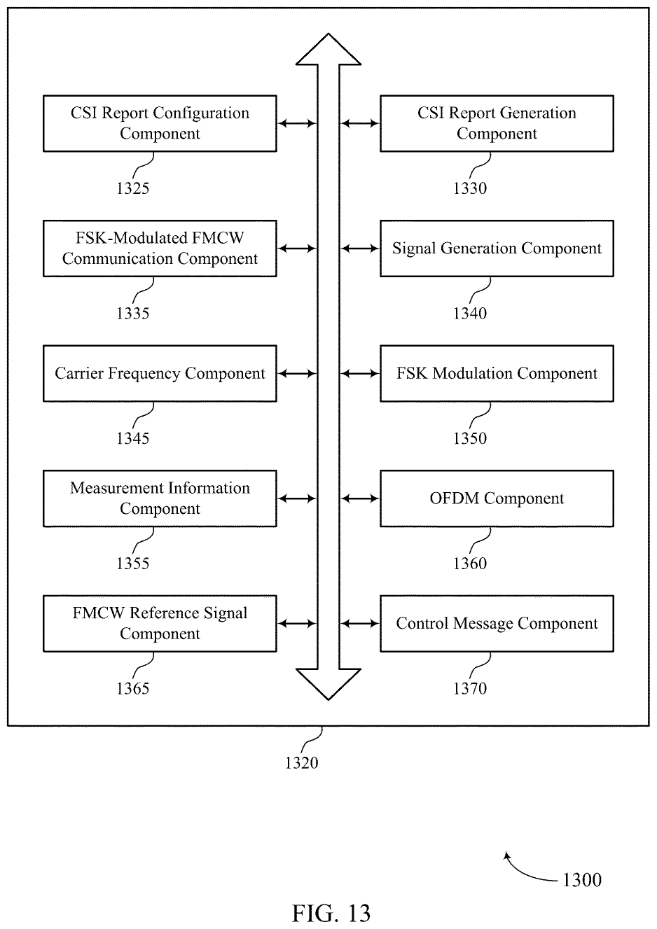

FIG. 13 illustrates a block diagram 1300 of a communications manager 1320 that supports CSI reporting for transmissions via FSK-modulated FMCWs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of CSI reporting for transmissions via FSK-modulated FMCWs as described herein. For example, the communications manager 1320 may include a CSI report configuration component 1325, a CSI report generation component 1330, an FSK-modulated FMCW communication component 1335, a signal generation component 1340, a carrier frequency component 1345, an FSK modulation component 1350, a measurement information component 1355, an OFDM component 1360, an FMCW reference signal component 1365, a control message component 1370, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a first network node in accordance with examples as disclosed herein. The CSI report configuration component 1325 may be configured as or otherwise support a means for receiving first information that indicates a first set of parameters for generation of a CSI report associated with a FMCW communication type. The CSI report generation component 1330 may be configured as or otherwise support a means for generating, based on the first set of parameters and based on measurement information corresponding to an FMCW-based reference signal, the CSI report, the CSI report including a second set of parameters for FSK-modulated FMCW communications between the first network node and a second network node. In some aspects, the CSI report generation component 1330 may be configured as or otherwise support a means for transmitting, before the FSK-modulated FMCW communications between the first network node and the second network node, the CSI report to the second network node.

In some aspects, the FSK-modulated FMCW communication component 1335 may be configured as or otherwise support a means for communicating data with the second network node via the FSK-modulated FMCW communications based on the second set of parameters.

In some aspects, the FSK-modulated FMCW communication component 1335 may be configured as or otherwise support a means for receiving second information that indicates a third set of parameters for the FSK-modulated FMCW communications between the first network node and the second network node, the third set of parameters being based on the second set of parameters. In some aspects, the FSK-modulated FMCW communication component 1335 may be configured as or otherwise support a means for communicating data with the second network node via the FSK-modulated FMCW communications based on the third set of parameters.

In some aspects, to support receiving the second information, the FSK-modulated FMCW communication component 1335 may be configured as or otherwise support a means for receiving an FSK-modulated FMCW signal, where the second information is FSK-modulated with the FSK-modulated FMCW signal. In some aspects, to support receiving the second information, the control message component 1370 may be configured as or otherwise support a means for receiving a control message including the second information.

In some aspects, the FMCW reference signal component 1365 may be configured as or otherwise support a means for transmitting a second FMCW-based reference signal, where the third set of parameters is further based on measurement information corresponding to the second FMCW-based reference signal.

In some aspects, to support receiving the first information, the CSI report configuration component 1325 may be configured as or otherwise support a means for receiving a CSI report configuration including the first information that indicates the first set of parameters. In some aspects, the FMCW reference signal component 1365 may be configured as or otherwise support a means for receiving the FMCW-based reference signal in accordance with a subset of FMCW parameters that are included in the first set of parameters indicated via the CSI report configuration.

In some aspects, to support receiving the first information, the FSK-modulated FMCW communication component 1335 may be configured as or otherwise support a means for receiving the FMCW-based reference signal including the first information, where the first information is FSK modulated with the FMCW-based reference signal, and where the FMCW-based reference signal is received in accordance with an initial set of parameters configured for FSK-modulated FMCW reference signals based on the first information being FSK-modulated with the FMCW-based reference signal.

In some aspects, to support generating the CSI report, the measurement information component 1355 may be configured as or otherwise support a means for determining a SNR associated with the FMCW-based reference signal, where the measurement information includes the SNR. In some aspects, to support generating the CSI report, the CSI report generation component 1330 may be configured as or otherwise support a means for determining, based on the SNR and from among a set of candidate quantities indicated via the first set of parameters, a quantity of frequency shifting periods for the FSK-modulated FMCW communications, where the second set of parameters for the FSK-modulated FMCW communications includes the quantity of frequency shifting periods.

In some aspects, each frequency shifting period of the quantity of frequency shifting periods corresponds to a respective period over which a respective subset of the FSK-modulated FMCW communications is modulated using a respective frequency shifting value of a set of candidate frequency shifting values. In some aspects, determining the quantity of frequency shifting periods includes determining the quantity of frequency shifting periods based on a quantity of candidate frequency shifting values in the set of candidate frequency shifting values.

In some aspects, to support generating the CSI report, the measurement information component 1355 may be configured as or otherwise support a means for estimating a maximum path delay based on the FMCW-based reference signal, where the measurement information includes the maximum path delay. In some aspects, to support generating the CSI report, the CSI report generation component 1330 may be configured as or otherwise support a means for determining, based on the estimated maximum path delay and from among a set of candidate frequency shifting intervals indicated via the first set of parameters, a frequency shifting interval, where the frequency shifting interval indicates a quantity of bits transmitted per frequency shifting period of the FSK-modulated FMCW communications, and where the second set of parameters includes the frequency shifting interval.

In some aspects, to support generating the CSI report, the measurement information component 1355 may be configured as or otherwise support a means for determining a SNR associated with the FMCW-based reference signal, where the measurement information includes the SNR. In some aspects, to support generating the CSI report, the CSI report generation component 1330 may be configured as or otherwise support a means for determining, based on second information and from among a set of candidate code rates indicated via the first set of parameters, a code rate, where the second information includes the SNR, a quantity of frequency shifting periods, and a frequency shifting interval, where the second set of parameters include the quantity of frequency shifting periods, the frequency shifting interval, and the code rate.

In some aspects, to support transmitting the CSI report, the FSK modulation component 1350 may be configured as or otherwise support a means for transmitting an FSK-modulated FMCW-based reference signal, where the CSI report is FSK-modulated with the FSK-modulated FMCW-based reference signal.

In some aspects, to support transmitting the FSK-modulated FMCW-based reference signal, the FSK modulation component 1350 may be configured as or otherwise support a means for transmitting the FSK-modulated FMCW-based reference signal in accordance with the first set of parameters indicated via the first information. Additionally, or alternatively, in some aspects, to support transmitting the FSK-modulated FMCW-based reference signal, the FSK modulation component 1350 may be configured as or otherwise support a means for transmitting the FSK-modulated FMCW-based reference signal in accordance with a third set of parameters configured for FSK-modulated FMCW reference signals.

In some aspects, to support transmitting the CSI report, the CSI report generation component 1330 may be configured as or otherwise support a means for transmitting the CSI report via an OFDM channel.

In some aspects, the FSK-modulated FMCW communications convey a stream of data bits. In some aspects, each bit of the stream of data bits is modulated using a respective carrier frequency selected from among three or more candidate carrier frequencies. In some aspects, a quantity of the three or more candidate carrier frequencies from which the respective carrier frequency is selected is based on a frequency shifting interval over which a single carrier frequency is applied and a bandwidth of the FSK-modulated FMCW communications. In some aspects, the frequency shifting interval and the bandwidth are based on the second set of parameters.

In some aspects, the first set of parameters includes a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, a periodicity associated with the CSI report, or any combination thereof.

In some aspects, the FMCW-based reference signal includes a CSI-RS.

Additionally, or alternatively, the communications manager 1320 may support wireless communication at a first network node in accordance with examples as disclosed herein. In some aspects, the CSI report configuration component 1325 may be configured as or otherwise support a means for transmitting first information that indicates a first set of parameters for generation of a CSI report associated with a FMCW communication type. The FSK-modulated FMCW communication component 1335 may be configured as or otherwise support a means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

In some aspects, the FSK-modulated FMCW communication component 1335 may be configured as or otherwise support a means for communicating data with the second network node via the FSK-modulated FMCW communications based on the second set of parameters.

In some aspects, the FSK-modulated FMCW communication component 1335 may be configured as or otherwise support a means for transmitting second information that indicates a third set of parameters for the FSK-modulated FMCW communications between the first network node and the second network node, the third set of parameters being based on the second set of parameters. In some aspects, the FSK-modulated FMCW communication component 1335 may be configured as or otherwise support a means for communicating data with the second network node via the FSK-modulated FMCW communications based on the third set of parameters.

In some aspects, to support transmitting the second information, the FSK modulation component 1350 may be configured as or otherwise support a means for transmitting an FSK-modulated FMCW signal, where the second information is FSK-modulated with the FSK-modulated FMCW signal. In some aspects, to support transmitting the second information, the control message component 1370 may be configured as or otherwise support a means for transmitting a control message including the second information.

In some aspects, the FMCW reference signal component 1365 may be configured as or otherwise support a means for receiving a second FMCW-based reference signal, where the third set of parameters is further based on measurement information corresponding to the second FMCW-based reference signal.

In some aspects, to support transmitting the first information, the CSI report configuration component 1325 may be configured as or otherwise support a means for transmitting a CSI report configuration including the first information that indicates the first set of parameters. In some aspects, the FMCW reference signal component 1365 may be configured as or otherwise support a means for transmitting the FMCW-based reference signal in accordance with a subset of FMCW parameters that are included in the first set of parameters indicated via the CSI report configuration.

In some aspects, to support transmitting the first information, the FSK modulation component 1350 may be configured as or otherwise support a means for transmitting the FMCW-based reference signal including the first information, where the first information is FSK modulated with the FMCW-based reference signal, and where the FMCW-based reference signal is transmitted in accordance with an initial set of parameters configured for FSK-modulated FMCW reference signals based on the first information being FSK-modulated with the FMCW-based reference signal.

In some aspects, to support receiving the CSI report, the FSK modulation component 1350 may be configured as or otherwise support a means for receiving an FSK-modulated FMCW-based reference signal, where the CSI report is FSK-modulated with the FSK-modulated FMCW-based reference signal.

In some aspects, to support receiving the CSI report, the OFDM component 1360 may be configured as or otherwise support a means for receiving the CSI report via an orthogonal frequency division multiplexing channel. In some aspects, to support receiving the CSI report, the FMCW reference signal component 1365 may be configured as or otherwise support a means for receiving a second FMCW-based reference signal in accordance with FMCW parameters included in the second set of parameters indicated via the CSI report.

In some aspects, the FSK-modulated FMCW communications convey a stream of data bits. In some aspects, each bit of the stream of data bits is modulated using a respective carrier frequency selected from among three or more candidate carrier frequencies. In some aspects, a quantity of the three or more candidate carrier frequencies from which the respective carrier frequency is selected is based on a frequency shifting interval over which a single carrier frequency is applied and a bandwidth of the FSK-modulated FMCW communications. In some aspects, the frequency shifting interval and the bandwidth are based on the second set of parameters.

In some aspects, the first set of parameters includes a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, or a periodicity associated with the CSI report, or any combination thereof.

In some aspects, the second set of parameters indicated via the CSI report includes a quantity of frequency shifting intervals, a frequency shifting interval duration, and a code rate.

Additionally, or alternatively, the communications manager 1320 may support wireless communication at a first network node in accordance with examples as disclosed herein. The signal generation component 1340 may be configured as or otherwise support a means for generating a FSK-modulated FMCW to convey a stream of data bits. In some aspects, to generate the FSK-modulated FMCW, the carrier frequency component 1345 may be configured as or otherwise support a means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. In some aspects, to generate the FSK-modulated FMCW, the FSK modulation component 1350 may be configured as or otherwise support a means for modulating the FSK-modulated FMCW using respective sinusoidal functions associated with the selected carrier frequencies. In some aspects, the FSK-modulated FMCW communication component 1335 may be configured as or otherwise support a means for transmitting the FSK-modulated FMCW that conveys the stream of data bits.

In some aspects, the FSK-modulated FMCW communication component 1335 may be configured as or otherwise support a means for receiving information that indicates a set of parameters for the FSK-modulated FMCW, where the set of parameters includes a quantity of frequency shifting periods included in the set of multiple frequency periods, a duration of each frequency shifting period of the set of multiple frequency shifting periods, and a code rate for the FSK-modulated FMCW. In some aspects, a quantity of the three or more candidate carrier frequencies is based on a frequency shift interval and a bandwidth of the FSK-modulated FMCW.

In some aspects, a quantity of data bits that are included in the subset of one or more data bits conveyed via a single frequency shifting period is based on a spreading factor of the FSK-modulated FMCW, a quantity of the three or more candidate carrier frequencies, and a quantity of frequency shifting periods included in the set of multiple frequency shifting periods.

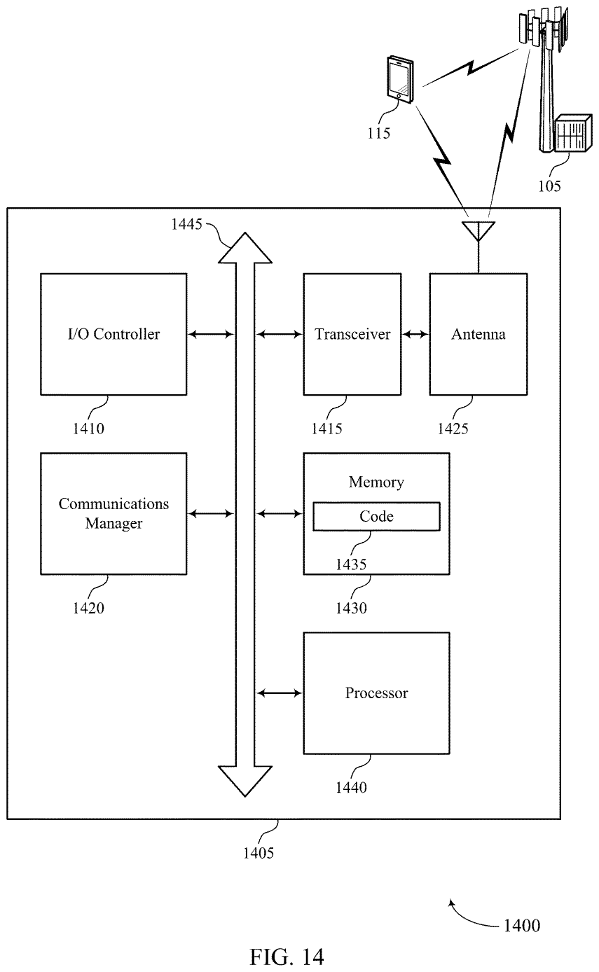

FIG. 14 illustrates a diagram of a system 1400 including a device 1405 that supports CSI reporting for transmissions via FSK-modulated FMCWs in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting CSI reporting for transmissions via FSK-modulated FMCWs). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communication at a first network node in accordance with examples as disclosed herein. For example, the communications manager 1420 may be configured as or otherwise support a means for receiving first information that indicates a first set of parameters for generation of a CSI report associated with a FMCW communication type. The communications manager 1420 may be configured as or otherwise support a means for generating, based on the first set of parameters and based on measurement information corresponding to an FMCW-based reference signal, the CSI report, the CSI report including a second set of parameters for FSK-modulated FMCW communications between the first network node and a second network node. The communications manager 1420 may be configured as or otherwise support a means for transmitting, before the FSK-modulated FMCW communications between the first network node and the second network node, the CSI report to the second network node.

Additionally, or alternatively, the communications manager 1420 may support wireless communication at a first network node in accordance with examples as disclosed herein. For example, the communications manager 1420 may be configured as or otherwise support a means for transmitting first information that indicates a first set of parameters for generation of a CSI report associated with a FMCW communication type. The communications manager 1420 may be configured as or otherwise support a means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Additionally, or alternatively, the communications manager 1420 may support wireless communication at a first network node in accordance with examples as disclosed herein. For example, the communications manager 1420 may be configured as or otherwise support a means for generating a FSK-modulated FMCW to convey a stream of data bits. In some aspects, to generate the FSK-modulated FMCW, the communications manager 1420 may be configured as or otherwise support a means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. In some aspects, to generate the FSK-modulated FMCW, the communications manager 1420 may be configured as or otherwise support a means for modulating the FSK-modulated FMCW using respective sinusoidal functions associated with the selected carrier frequencies. The communications manager 1420 may be configured as or otherwise support a means for transmitting the FSK-modulated FMCW that conveys the stream of data bits.

By including or configuring the communications manager 1420 in accordance with examples as described herein, the device 1405 may support techniques for improved FSK-modulated FMCW communication reliability and throughput, reduced latency, reduced power consumption, more efficient utilization of communication resources, and improved coordination between devices.

In some aspects, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some aspects, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of CSI reporting for transmissions via FSK-modulated FMCWs as described herein, or the processor 1440 and the memory 1430 may be otherwise configured to perform or support such operations.

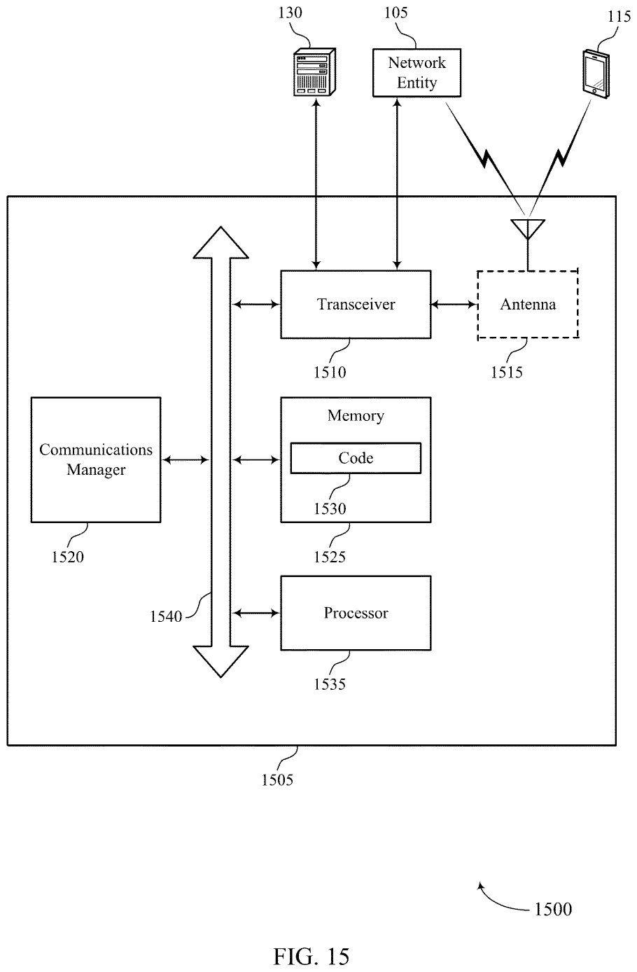

FIG. 15 illustrates a diagram of a system 1500 including a device 1505 that supports CSI reporting for transmissions via FSK-modulated FMCWs in accordance with one or more aspects of the present disclosure. The device 1505 may be an example of or include the components of a device 1105, a device 1205, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some aspects, the transceiver 1510 may include a wired transceiver and may communicate bi-directionally with another wired transceiver. Additionally, or alternatively, in some aspects, the transceiver 1510 may include a wireless transceiver and may communicate bi-directionally with another wireless transceiver. In some aspects, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some aspects, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting CSI reporting for transmissions via FSK-modulated FMCWs). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1540 may support communications of (e.g., within) a protocol layer of a protocol stack. In some aspects, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some aspects, the communications manager 1520 may manage aspects of communications with a core network 130 (e.g., via one or more wired or wireless backhaul links). For example, the communications manager 1520 may manage the transfer of data communications for client devices, such as one or more UEs 115. In some aspects, the communications manager 1520 may manage communications with other network entities 105, and may include a controller or scheduler for controlling communications with UEs 115 in cooperation with other network entities 105. In some aspects, the communications manager 1520 may support an X2 interface within an LTE/LTE-A wireless communications network technology to provide communication between network entities 105.

The communications manager 1520 may support wireless communication at a first network node in accordance with examples as disclosed herein. For example, the communications manager 1520 may be configured as or otherwise support a means for receiving first information that indicates a first set of parameters for generation of a CSI report associated with a FMCW communication type. The communications manager 1520 may be configured as or otherwise support a means for generating, based on the first set of parameters and based on measurement information corresponding to an FMCW-based reference signal, the CSI report, the CSI report including a second set of parameters for FSK-modulated FMCW communications between the first network node and a second network node. The communications manager 1520 may be configured as or otherwise support a means for transmitting, before the FSK-modulated FMCW communications between the first network node and the second network node, the CSI report to the second network node.

Additionally, or alternatively, the communications manager 1520 may support wireless communication at a first network node in accordance with examples as disclosed herein. For example, the communications manager 1520 may be configured as or otherwise support a means for transmitting first information that indicates a first set of parameters for generation of a CSI report associated with a FMCW communication type. The communications manager 1520 may be configured as or otherwise support a means for receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal.

Additionally, or alternatively, the communications manager 1520 may support wireless communication at a first network node in accordance with examples as disclosed herein. For example, the communications manager 1520 may be configured as or otherwise support a means for generating a FSK-modulated FMCW to convey a stream of data bits. In some aspects, to generate the FSK-modulated FMCW, the communications manager 1520 may be configured as or otherwise support a means for selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. In some aspects, to generate the FSK-modulated FMCW, the communications manager 1520 may be configured as or otherwise support a means for modulating the FSK-modulated FMCW using respective sinusoidal functions associated with the selected carrier frequencies. The communications manager 1520 may be configured as or otherwise support a means for transmitting the FSK-modulated FMCW that conveys the stream of data bits.

By including or configuring the communications manager 1520 in accordance with examples as described herein, the device 1505 may support techniques for improved FSK-modulated FMCW communication reliability and throughput, reduced latency, reduced power consumption, more efficient utilization of communication resources, and improved coordination between devices.

In some aspects, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some aspects, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of CSI reporting for transmissions via FSK-modulated FMCWs as described herein, or the processor 1535 and the memory 1525 may be otherwise configured to perform or support such operations.

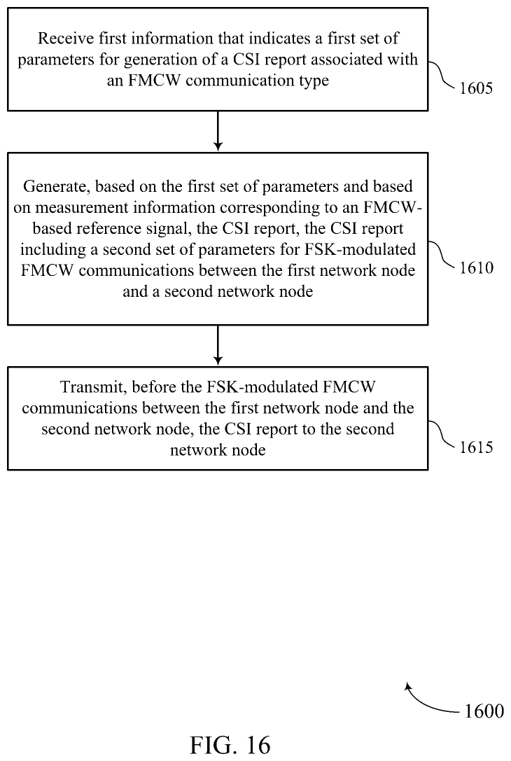

FIG. 16 illustrates a flowchart showing a method 1600 that supports CSI reporting for transmissions via FSK-modulated FMCWs in accordance with one or more aspects of the present disclosure. The operations of the method 1600 may be implemented by a UE or a network entity or its components as described herein. For example, the operations of the method 1600 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving first information that indicates a first set of parameters for generation of a CSI report associated with a FMCW communication type. The operations of 1605 may be performed in accordance with examples as disclosed herein. In some aspects, aspects of the operations of 1605 may be performed by a CSI report configuration component 1325 as described with reference to FIG. 13.

At 1610, the method may include generating, based on the first set of parameters and based on measurement information corresponding to an FMCW-based reference signal, the CSI report, the CSI report including a second set of parameters for FSK-modulated FMCW communications between the first network node and a second network node. The operations of 1610 may be performed in accordance with examples as disclosed herein. In some aspects, aspects of the operations of 1610 may be performed by a CSI report generation component 1330 as described with reference to FIG. 13.

At 1615, the method may include transmitting, before the FSK-modulated FMCW communications between the first network node and the second network node, the CSI report to the second network node. The operations of 1615 may be performed in accordance with examples as disclosed herein. In some aspects, aspects of the operations of 1615 may be performed by a CSI report generation component 1330 as described with reference to FIG. 13.

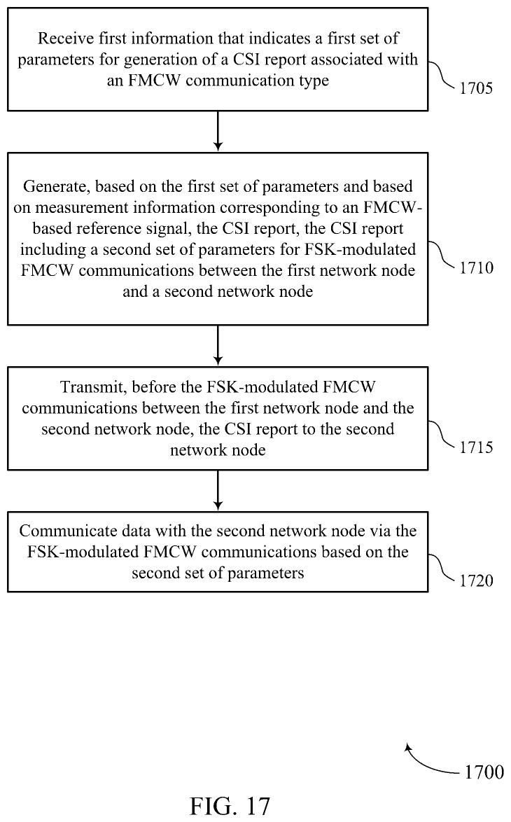

FIG. 17 illustrates a flowchart showing a method 1700 that supports CSI reporting for transmissions via FSK-modulated FMCWs in accordance with one or more aspects of the present disclosure. The operations of the method 1700 may be implemented by a UE or a network entity or its components as described herein. For example, the operations of the method 1700 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include receiving first information that indicates a first set of parameters for generation of a CSI report associated with a FMCW communication type. The operations of 1705 may be performed in accordance with examples as disclosed herein. In some aspects, aspects of the operations of 1705 may be performed by a CSI report configuration component 1325 as described with reference to FIG. 13.

At 1710, the method may include generating, based on the first set of parameters and based on measurement information corresponding to an FMCW-based reference signal, the CSI report, the CSI report including a second set of parameters for FSK-modulated FMCW communications between the first network node and a second network node. The operations of 1710 may be performed in accordance with examples as disclosed herein. In some aspects, aspects of the operations of 1710 may be performed by a CSI report generation component 1330 as described with reference to FIG. 13.

At 1715, the method may include transmitting, before the FSK-modulated FMCW communications between the first network node and the second network node, the CSI report to the second network node. The operations of 1715 may be performed in accordance with examples as disclosed herein. In some aspects, aspects of the operations of 1715 may be performed by a CSI report generation component 1330 as described with reference to FIG. 13.

At 1720, the method may include communicating data with the second network node via the FSK-modulated FMCW communications based on the second set of parameters. The operations of 1720 may be performed in accordance with examples as disclosed herein. In some aspects, aspects of the operations of 1720 may be performed by an FSK-modulated FMCW communication component 1335 as described with reference to FIG. 13.

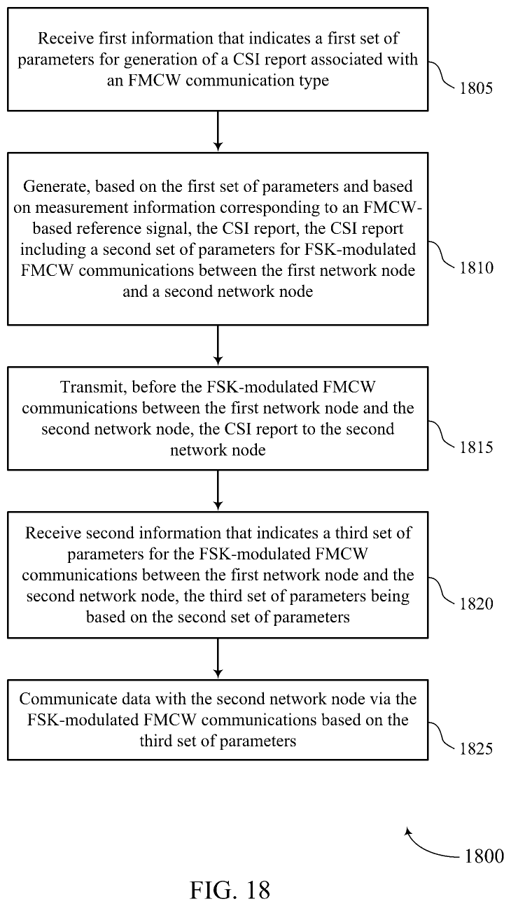

FIG. 18 illustrates a flowchart showing a method 1800 that supports CSI reporting for transmissions via FSK-modulated FMCWs in accordance with one or more aspects of the present disclosure. The operations of the method 1800 may be implemented by a UE or a network entity or its components as described herein. For example, the operations of the method 1800 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving first information that indicates a first set of parameters for generation of a CSI report associated with a FMCW communication type. The operations of 1805 may be performed in accordance with examples as disclosed herein. In some aspects, aspects of the operations of 1805 may be performed by a CSI report configuration component 1325 as described with reference to FIG. 13.

At 1810, the method may include generating, based on the first set of parameters and based on measurement information corresponding to an FMCW-based reference signal, the CSI report, the CSI report including a second set of parameters for FSK-modulated FMCW communications between the first network node and a second network node. The operations of 1810 may be performed in accordance with examples as disclosed herein. In some aspects, aspects of the operations of 1810 may be performed by a CSI report generation component 1330 as described with reference to FIG. 13.

At 1815, the method may include transmitting, before the FSK-modulated FMCW communications between the first network node and the second network node, the CSI report to the second network node. The operations of 1815 may be performed in accordance with examples as disclosed herein. In some aspects, aspects of the operations of 1815 may be performed by a CSI report generation component 1330 as described with reference to FIG. 13.

At 1820, the method may include receiving second information that indicates a third set of parameters for the FSK-modulated FMCW communications between the first network node and the second network node, the third set of parameters being based on the second set of parameters. The operations of 1820 may be performed in accordance with examples as disclosed herein. In some aspects, aspects of the operations of 1820 may be performed by an FSK-modulated FMCW communication component 1335 as described with reference to FIG. 13.

At 1825, the method may include communicating data with the second network node via the FSK-modulated FMCW communications based on the third set of parameters. The operations of 1825 may be performed in accordance with examples as disclosed herein. In some aspects, aspects of the operations of 1825 may be performed by an FSK-modulated FMCW communication component 1335 as described with reference to FIG. 13.

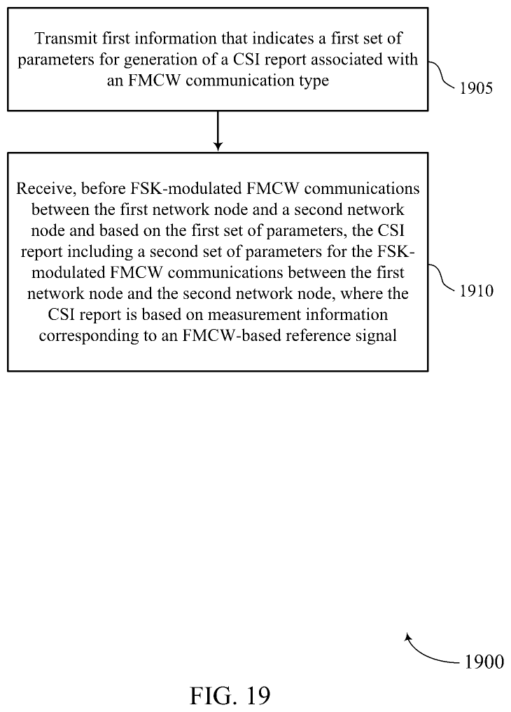

FIG. 19 illustrates a flowchart showing a method 1900 that supports CSI reporting for transmissions via FSK-modulated FMCWs in accordance with one or more aspects of the present disclosure. The operations of the method 1900 may be implemented by a UE or a network entity or its components as described herein. For example, the operations of the method 1900 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include transmitting first information that indicates a first set of parameters for generation of a CSI report associated with a FMCW communication type. The operations of 1905 may be performed in accordance with examples as disclosed herein. In some aspects, aspects of the operations of 1905 may be performed by a CSI report configuration component 1325 as described with reference to FIG. 13.

At 1910, the method may include receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to an FMCW-based reference signal. The operations of 1910 may be performed in accordance with examples as disclosed herein. In some aspects, aspects of the operations of 1910 may be performed by an FSK-modulated FMCW communication component 1335 as described with reference to FIG. 13.

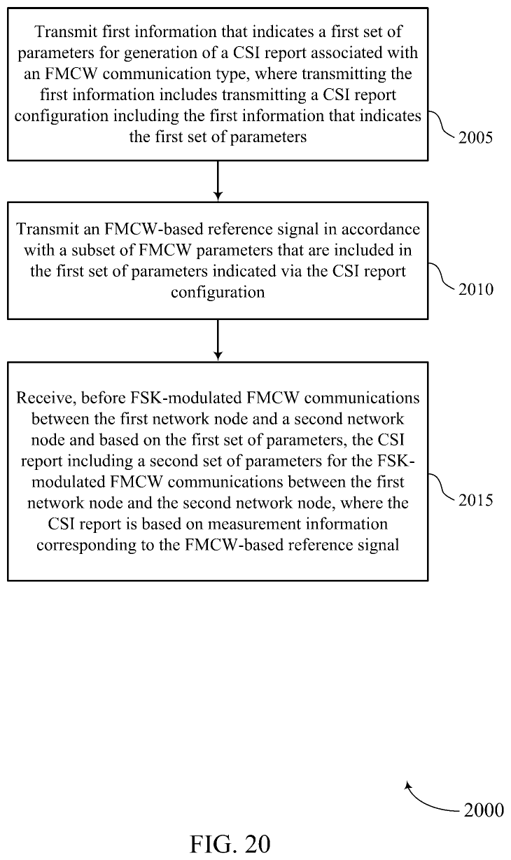

FIG. 20 illustrates a flowchart showing a method 2000 that supports CSI reporting for transmissions via FSK-modulated FMCWs in accordance with one or more aspects of the present disclosure. The operations of the method 2000 may be implemented by a UE or a network entity or its components as described herein. For example, the operations of the method 2000 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include transmitting first information that indicates a first set of parameters for generation of a CSI report associated with a FMCW communication type, where transmitting the first information may include transmitting a CSI report configuration including the first information that indicates the first set of parameters. The operations of 2005 may be performed in accordance with examples as disclosed herein. In some aspects, aspects of the operations of 2005 may be performed by a CSI report configuration component 1325 as described with reference to FIG. 13.

At 2010, the method may include transmitting an FMCW-based reference signal in accordance with a subset of FMCW parameters that are included in the first set of parameters indicated via the CSI report configuration. The operations of 2010 may be performed in accordance with examples as disclosed herein. In some aspects, aspects of the operations of 2010 may be performed by an FMCW reference signal component 1365 as described with reference to FIG. 13.

At 2015, the method may include receiving, before FSK-modulated FMCW communications between the first network node and a second network node and based on the first set of parameters, the CSI report including a second set of parameters for the FSK-modulated FMCW communications between the first network node and the second network node, where the CSI report is based on measurement information corresponding to the FMCW-based reference signal. The operations of 2015 may be performed in accordance with examples as disclosed herein. In some aspects, aspects of the operations of 2015 may be performed by an FSK-modulated FMCW communication component 1335 as described with reference to FIG. 13.

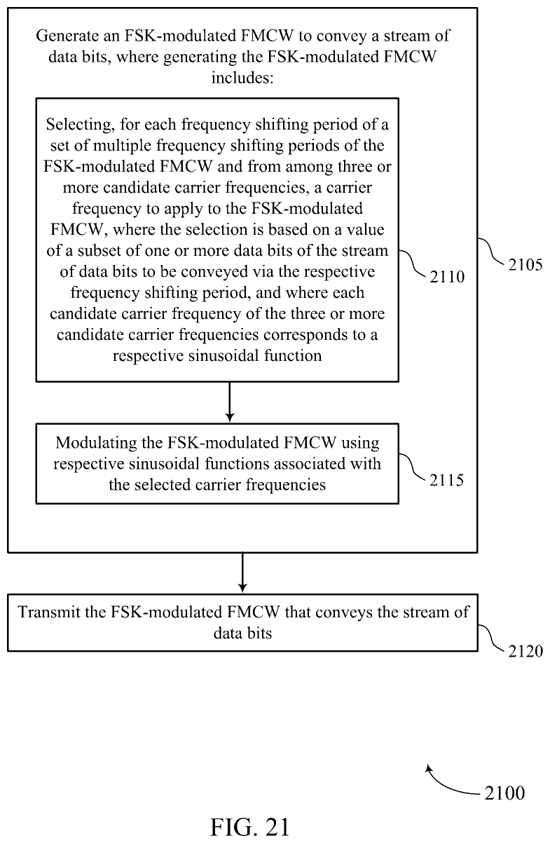

FIG. 21 illustrates a flowchart showing a method 2100 that supports CSI reporting for transmissions via FSK-modulated FMCWs in accordance with one or more aspects of the present disclosure. The operations of the method 2100 may be implemented by a UE or a network entity or its components as described herein. For example, the operations of the method 2100 may be performed by a UE 115 or a network entity as described with reference to FIGs. FIG. 1 through 15. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 2105, the method may include generating a FSK-modulated FMCW to convey a stream of data bits. The operations of 2105 may be performed in accordance with examples as disclosed herein. In some aspects, aspects of the operations of 2105 may be performed by a signal generation component 1340 as described with reference to FIG. 13.

At 2110, as part of generating the FSK-modulated FMCW, the method may include selecting, for each frequency shifting period of a set of multiple frequency shifting periods of the FSK-modulated FMCW and from among three or more candidate carrier frequencies, a carrier frequency to apply to the FSK-modulated FMCW, where the selection is based on a value of a subset of one or more data bits of the stream of data bits to be conveyed via the respective frequency shifting period, and where each candidate carrier frequency of the three or more candidate carrier frequencies corresponds to a respective sinusoidal function. The operations of 2110 may be performed in accordance with examples as disclosed herein. In some aspects, aspects of the operations of 2110 may be performed by a carrier frequency component 1345 as described with reference to FIG. 13.

At 2115, as part of generating the FSK-modulated FMCW, the method may include modulating the FSK-modulated FMCW using respective sinusoidal functions associated with the selected carrier frequencies. The operations of 2115 may be performed in accordance with examples as disclosed herein. In some aspects, aspects of the operations of 2115 may be performed by an FSK modulation component 1350 as described with reference to FIG. 13.

At 2120, the method may include transmitting the FSK-modulated FMCW that conveys the stream of data bits. The operations of 2120 may be performed in accordance with examples as disclosed herein. In some aspects, aspects of the operations of 2120 may be performed by an FSK-modulated FMCW communication component 1335 as described with reference to FIG. 13.

The following provides an overview of aspects of the present disclosure:
Aspect 1: A method for wireless communication at a first network node, comprising: receiving first information that indicates a first set of parameters for generation of a CSI report associated with an FMCW communication type; generating, based on the first set of parameters and based on measurement information corresponding to an FMCW-based reference signal, the CSI report, the CSI report including a second set of parameters for FSK-modulated FMCW communications between the first network node and a second network node; and transmitting, before the FSK-modulated FMCW communications between the first network node and the second network node, the CSI report to the second network node.
Aspect 2: The method of aspect 1, further comprising: communicating data with the second network node via the FSK-modulated FMCW communications based on the second set of parameters.
Aspect 3: The method of aspect 1, further comprising: receiving second information that indicates a third set of parameters for the FSK-modulated FMCW communications between the first network node and the second network node, the third set of parameters being based on the second set of parameters; and communicating data with the second network node via the FSK-modulated FMCW communications based on the third set of parameters.
Aspect 4: The method of aspect 3, wherein receiving the second information comprises: receiving an FSK-modulated FMCW signal, wherein the second information is FSK-modulated with the FSK-modulated FMCW signal.
Aspect 5: The method of aspect 3, wherein receiving the second information comprises: receiving a control message comprising the second information.
Aspect 6: The method of any of aspects 3 through 5, further comprising: transmitting a second FMCW-based reference signal, wherein the third set of parameters is further based on measurement information corresponding to the second FMCW-based reference signal.
Aspect 7: The method of any of aspects 1 through 6, wherein receiving the first information comprises: receiving a CSI report configuration comprising the first information that indicates the first set of parameters, wherein the method further comprises: receiving the FMCW-based reference signal in accordance with a subset of FMCW parameters that are included in the first set of parameters indicated via the CSI report configuration.
Aspect 8: The method of any of aspects 1 through 6, wherein receiving the first information comprises: receiving the FMCW-based reference signal comprising the first information, wherein the first information is FSK modulated with the FMCW-based reference signal, and wherein the FMCW-based reference signal is received in accordance with an initial set of parameters configured for FSK-modulated FMCW reference signals based on the first information being FSK-modulated with the FMCW-based reference signal.
Aspect 9: The method of any of aspects 1 through 8, wherein generating the CSI report comprises: determining an SNR associated with the FMCW-based reference signal, wherein the measurement information comprises the SNR; and determining, based on the SNR and from among a set of candidate quantities indicated via the first set of parameters, a quantity of frequency shifting periods for the FSK-modulated FMCW communications, wherein the second set of parameters for the FSK-modulated FMCW communications comprises the quantity of frequency shifting periods.
Aspect 10: The method of aspect 9, wherein each frequency shifting period of the quantity of frequency shifting periods corresponds to a respective period over which a respective subset of the FSK-modulated FMCW communications is modulated using a respective frequency shifting value of a set of candidate frequency shifting values; and determining the quantity of frequency shifting periods comprises determining the quantity of frequency shifting periods based on a quantity of candidate frequency shifting values in the set of candidate frequency shifting values.
Aspect 11: The method of any of aspects 1 through 10, wherein generating the CSI report comprises: estimating a maximum path delay based on the FMCW-based reference signal, wherein the measurement information comprises the maximum path delay; and determining, based on the estimated maximum path delay and from among a set of candidate frequency shifting intervals indicated via the first set of parameters, a frequency shifting interval, wherein the frequency shifting interval indicates a quantity of bits transmitted per frequency shifting period of the FSK-modulated FMCW communications, and wherein the second set of parameters comprises the frequency shifting interval.
Aspect 12: The method of any of aspects 1 through 11, wherein generating the CSI report comprises: determining an SNR associated with the FMCW-based reference signal, wherein the measurement information comprises the SNR; and determining, based on second information and from among a set of candidate code rates indicated via the first set of parameters, a code rate, wherein the second information includes the SNR, a quantity of frequency shifting periods, and a frequency shifting interval, wherein the second set of parameters comprise the quantity of frequency shifting periods, the frequency shifting interval, and the code rate.
Aspect 13: The method of any of aspects 1 through 12, wherein transmitting the CSI report comprises: transmitting an FSK-modulated FMCW-based reference signal, wherein the CSI report is FSK-modulated with the FSK-modulated FMCW-based reference signal.
Aspect 14: The method of aspect 13, wherein transmitting the FSK-modulated FMCW-based reference signal comprises: transmitting the FSK-modulated FMCW-based reference signal in accordance with the first set of parameters indicated via the first information; or transmitting the FSK-modulated FMCW-based reference signal in accordance with a third set of parameters configured for FSK-modulated FMCW reference signals.
Aspect 15: The method of any of aspects 1 through 12, wherein transmitting the CSI report comprises: transmitting the CSI report via an OFDM channel.
Aspect 16: The method of any of aspects 1 through 15, wherein the FSK-modulated FMCW communications convey a stream of data bits; each bit of the stream of data bits is modulated using a respective carrier frequency selected from among three or more candidate carrier frequencies; a quantity of the three or more candidate carrier frequencies from which the respective carrier frequency is selected is based on a frequency shifting interval over which a single carrier frequency is applied and a bandwidth of the FSK-modulated FMCW communications; and the frequency shifting interval and the bandwidth are based on the second set of parameters.
Aspect 17: The method of any of aspects 1 through 16, wherein the first set of parameters comprises a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, a periodicity associated with the CSI report, or any combination thereof.
Aspect 18: The method of any of aspects 1 through 17, wherein the FMCW-based reference signal comprises a CSI-RS.
Aspect 19: A method for wireless communication at a first network node, comprising: transmitting first information that indicates a first set of parameters for generation of a CSI report associated with an FMCW communication type; and receiving, before FSK-modulated FMCW communications between the first network node and a second network node and based on the first set of parameters, the CSI report including a second set of parameters for the FSK-modulated FMCW communications between the first network node and the second network node, wherein the CSI report is based on measurement information corresponding to an FMCW-based reference signal.
Aspect 20: The method of aspect 19, further comprising: communicating data with the second network node via the FSK-modulated FMCW communications based on the second set of parameters.
Aspect 21: The method of aspect 19, further comprising: transmitting second information that indicates a third set of parameters for the FSK-modulated FMCW communications between the first network node and the second network node, the third set of parameters being based on the second set of parameters; and communicating data with the second network node via the FSK-modulated FMCW communications based on the third set of parameters.
Aspect 22: The method of aspect 21, wherein transmitting the second information comprises: transmitting an FSK-modulated FMCW signal, wherein the second information is FSK-modulated with the FSK-modulated FMCW signal.
Aspect 23: The method of aspect 21, wherein transmitting the second information comprises: transmitting a control message comprising the second information.
Aspect 24: The method of any of aspects 21 through 23, further comprising: receiving a second FMCW-based reference signal, wherein the third set of parameters is further based on measurement information corresponding to the second FMCW-based reference signal.
Aspect 25: The method of any of aspects 19 through 24, wherein transmitting the first information comprises: transmitting a CSI report configuration comprising the first information that indicates the first set of parameters, the method further comprising: transmitting the FMCW-based reference signal in accordance with a subset of FMCW parameters that are included in the first set of parameters indicated via the CSI report configuration.
Aspect 26: The method of any of aspects 19 through 24, wherein transmitting the first information comprises: transmitting the FMCW-based reference signal comprising the first information, wherein the first information is FSK modulated with the FMCW-based reference signal, and wherein the FMCW-based reference signal is transmitted in accordance with an initial set of parameters configured for FSK-modulated FMCW reference signals based on the first information being FSK-modulated with the FMCW-based reference signal.
Aspect 27: The method of any of aspects 19 through 26, wherein receiving the CSI report comprises: receiving an FSK-modulated FMCW-based reference signal, wherein the CSI report is FSK-modulated with the FSK-modulated FMCW-based reference signal.
Aspect 28: The method of any of aspects 19 through 26, wherein receiving the CSI report comprises: receiving the CSI report via an OFDM channel; and receiving a second FMCW-based reference signal in accordance with FMCW parameters included in the second set of parameters indicated via the CSI report.
Aspect 29: The method of any of aspects 19 through 28, wherein the FSK-modulated FMCW communications convey a stream of data bits; each bit of the stream of data bits is modulated using a respective carrier frequency selected from among three or more candidate carrier frequencies; a quantity of the three or more candidate carrier frequencies from which the respective carrier frequency is selected is based on a frequency shifting interval over which a single carrier frequency is applied and a bandwidth of the FSK-modulated FMCW communications; and the frequency shifting interval and the bandwidth are based on the second set of parameters.
Aspect 30: The method of any of aspects 19 through 29, wherein the first set of parameters comprises a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the CSI report, or a periodicity associated with the CSI report, or any combination thereof.
Aspect 31: The method of any of aspects 19 through 30, wherein the second set of parameters indicated via the CSI report comprises a quantity of frequency shifting intervals, a frequency shifting interval duration, and a code rate.
Aspect 32: A method for wireless communication at a first network node, comprising: generating an FSK-modulated FMCW to convey a stream of data bits, wherein, generating the FSK-modulated FMCW comprises: selecting, for each frequency shifting period of a plurality of frequency shifting periods of the FSK-modulated FMCW and from among three or more candidate carrier frequencies, a carrier frequency to apply to the FSK-modulated FMCW, wherein the selection is based on a value of a subset of one or more data bits of the stream of data bits to be conveyed via the respective frequency shifting period, and wherein each candidate carrier frequency of the three or more candidate carrier frequencies corresponds to a respective sinusoidal function; and modulating the FSK-modulated FMCW using respective sinusoidal functions associated with the selected carrier frequencies; and transmitting the FSK-modulated FMCW that conveys the stream of data bits.
Aspect 33: The method of aspect 32, further comprising: receiving information that indicates a set of parameters for the FSK-modulated FMCW, wherein the set of parameters comprises a quantity of frequency shifting periods included in the plurality of frequency periods, a duration of each frequency shifting period of the plurality of frequency shifting periods, and a code rate for the FSK-modulated FMCW.
Aspect 34: The method of any of aspects 32 through 33, wherein a quantity of the three or more candidate carrier frequencies is based on a frequency shift interval and a bandwidth of the FSK-modulated FMCW.
Aspect 35: The method of any of aspects 32 through 34, wherein a quantity of data bits that are included in the subset of one or more data bits conveyed via a single frequency shifting period is based on a spreading factor of the FSK-modulated FMCW, a quantity of the three or more candidate carrier frequencies, and a quantity of frequency shifting periods included in the plurality of frequency shifting periods.
Aspect 36: An apparatus for wireless communication at a first network node, comprising a communication interface and at least one processor coupled to the communication interface, wherein the at least one processor is configured to perform a method of any of aspects 1 through 18.
Aspect 37: An apparatus for wireless communication at a first network node, comprising at least one means for performing a method of any of aspects 1 through 18.
Aspect 38: A non-transitory computer-readable medium storing code for wireless communication at a first network node, the code comprising instructions executable by a processor to perform a method of any of aspects 1 through 18.
Aspect 39: An apparatus for wireless communication at a first network node, comprising a communication interface and at least one processor coupled to the communication interface, wherein the at least one processor is configured to perform a method of any of aspects 19 through 31.
Aspect 40: An apparatus for wireless communication at a first network node, comprising at least one means for performing a method of any of aspects 19 through 31.
Aspect 41: A non-transitory computer-readable medium storing code for wireless communication at a first network node, the code comprising instructions executable by a processor to perform a method of any of aspects 19 through 31.
Aspect 42: An apparatus for wireless communication at a first network node, comprising a communication interface and at least one processor coupled to the communication interface, wherein the at least one processor is configured to perform a method of any of aspects 32 through 35.
Aspect 43: An apparatus for wireless communication at a first network node, comprising at least one means for performing a method of any of aspects 32 through 35.
Aspect 44: A non-transitory computer-readable medium storing code for wireless communication at a first network node, the code comprising instructions executable by a processor to perform a method of any of aspects 32 through 35.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

In some aspects, the functions described herein may be implemented using a communication interface of a network node. A communication interface may be coupled with a processor of the network node. The processor may be configured to receive one or more signals via the communication interface. The processor may be configured to cause transmission of one or more signals using the communication interface. In some aspects, the processor being configured to cause transmission of a signal may refer to the processor performing the transmission. In some other aspects, the processor being configured to cause transmission of a signal may refer to the processor providing information to another component to perform the transmission.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
a communication interface; and
at least one processor coupled to the communication interface, wherein the at least one processor is configured to:
receive, via the communication interface, first information that indicates a first set of parameters for generation of a channel state information report associated with a frequency modulated continuous waveform (FMCW) communication type;
generate, based on the first set of parameters and based on measurement information corresponding to an FMCW-based reference signal, the channel state information report, the channel state information report including a second set of parameters for frequency shift keying (FSK)-modulated FMCW communications between the first network node and a second network node; and
cause, before the FSK-modulated FMCW communications between the first network node and the second network node, transmission of the channel state information report to the second network node.

2. The first network node of claim 1, wherein the at least one processor is further configured to:
communicate data with the second network node via the FSK-modulated FMCW communications based on the second set of parameters.

3. The first network node of claim 1, wherein the at least one processor is further configured to:
receive, via the communication interface, second information that indicates a third set of parameters for the FSK-modulated FMCW communications between the first network node and the second network node, the third set of parameters being based on the second set of parameters; and
communicate data with the second network node via the FSK-modulated FMCW communications based on the third set of parameters.

4. The first network node of claim 3, wherein, to receive the second information, the at least one processor is configured to:
receive, via the communication interface, an FSK-modulated FMCW signal, wherein the second information is FSK-modulated with the FSK-modulated FMCW signal.

5. The first network node of claim 3, wherein, to receive the second information, the at least one processor is configured to:
receive, via the communication interface, a control message comprising the second information.

6. The first network node of claim 3, wherein the at least one processor is further configured to:
cause transmission of a second FMCW-based reference signal, wherein the third set of parameters is further based on measurement information corresponding to the second FMCW-based reference signal.

7. The first network node of claim 1, wherein, to receive the first information, the at least one processor is configured to:
receive, via the communication interface, a channel state information report configuration comprising the first information that indicates the first set of parameters, wherein the at least one processor is further configured to:
receive, via the communication interface, the FMCW-based reference signal in accordance with a subset of FMCW parameters that are included in the first set of parameters indicated via the channel state information report configuration.

8. The first network node of claim 1, wherein, to receive the first information, the at least one processor is configured to:
receive, via the communication interface, the FMCW-based reference signal comprising the first information, wherein the first information is FSK modulated with the FMCW-based reference signal, and wherein the FMCW-based reference signal is received in accordance with an initial set of parameters configured for FSK-modulated FMCW reference signals based on the first information being FSK-modulated with the FMCW-based reference signal.

9. The first network node of claim 1, wherein, to generate the channel state information report, the at least one processor is configured to:
determine a signal-to-noise ratio associated with the FMCW-based reference signal, wherein the measurement information comprises the signal-to-noise ratio; and
determine, based on the signal-to-noise ratio and from among a set of candidate quantities indicated via the first set of parameters, a quantity of frequency shifting periods for the FSK-modulated FMCW communications, wherein the second set of parameters for the FSK-modulated FMCW communications comprises the quantity of frequency shifting periods.

10. The first network node of claim 9, wherein:
each frequency shifting period of the quantity of frequency shifting periods corresponds to a respective period over which a respective subset of the FSK-modulated FMCW communications is modulated using a respective frequency shifting value of a set of candidate frequency shifting values; and
to determine the quantity of frequency shifting periods, the at least one processor is configured to determine the quantity of frequency shifting periods based on a quantity of candidate frequency shifting values in the set of candidate frequency shifting values.

11. The first network node of claim 1, wherein, to generate the channel state information report, the at least one processor is configured to:
estimate a maximum path delay based on the FMCW-based reference signal, wherein the measurement information comprises the maximum path delay; and
determine, based on the estimated maximum path delay and from among a set of candidate frequency shifting intervals indicated via the first set of parameters, a frequency shifting interval, wherein the frequency shifting interval indicates a quantity of bits transmitted per frequency shifting period of the FSK-modulated FMCW communications, and wherein the second set of parameters comprises the frequency shifting interval.

12. The first network node of claim 1, wherein, to generate the channel state information report, the at least one processor is configured to:
determine a signal-to-noise ratio associated with the FMCW-based reference signal, wherein the measurement information comprises the signal-to-noise ratio; and
determine, based on second information and from among a set of candidate code rates indicated via the first set of parameters, a code rate, wherein the second information includes the signal-to-noise ratio, a quantity of frequency shifting periods, and a frequency shifting interval, wherein the second set of parameters comprise the quantity of frequency shifting periods, the frequency shifting interval, and the code rate.

13. The first network node of claim 1, wherein, to cause the transmission of the channel state information report, the at least one processor is configured to:
cause transmission of an FSK-modulated FMCW-based reference signal, wherein the channel state information report is FSK-modulated with the FSK-modulated FMCW-based reference signal.

14. The first network node of claim 13, wherein, to cause the transmission of the FSK-modulated FMCW-based reference signal, the at least one processor is configured to:
cause the transmission of the FSK-modulated FMCW-based reference signal in accordance with the first set of parameters indicated via the first information; or
cause the transmission of the FSK-modulated FMCW-based reference signal in accordance with a third set of parameters configured for FSK-modulated FMCW reference signals.

15. The first network node of claim 1, wherein, to cause the transmission of the channel state information report, the at least one processor is further configured to:
cause transmission of the channel state information report via an orthogonal frequency division multiplexing channel.

16. The first network node of claim 1, wherein:
the FSK-modulated FMCW communications convey a stream of data bits;
each bit of the stream of data bits is modulated using a respective carrier frequency selected from among three or more candidate carrier frequencies;
a quantity of the three or more candidate carrier frequencies from which the respective carrier frequency is selected is based on a frequency shifting interval over which a single carrier frequency is applied and a bandwidth of the FSK-modulated FMCW communications; and
the frequency shifting interval and the bandwidth are based on the second set of parameters.

17. The first network node of claim 1, wherein the first set of parameters comprises a set of candidate quantities of frequency shifting periods in a single FMCW chirp duration, a set of candidate values for frequency shifting intervals in a single frequency shifting period, a set of candidate code rates, a quantity of symbols per FMCW chirp duration, a duration of an FMCW chirp, a bandwidth of an FMCW signal, a type of the channel state information report, a periodicity associated with the channel state information report, or any combination thereof.

18. The first network node of claim 1, wherein the FMCW-based reference signal comprises a channel state information reference signal.

19. A first network node for wireless communication, comprising:
a communication interface; and
at least one processor coupled to the communication interface, wherein the at least one processor is configured to:
cause transmission of first information that indicates a first set of parameters for generation of a channel state information report associated with a frequency modulated continuous waveform (FMCW) communication type; and
receive, via the communication interface before frequency shift keying (FSK)-modulated FMCW communications between the first network node and a second network node and based on the first set of parameters, the channel state information report including a second set of parameters for theFSK-modulated FMCW communications between the first network node and the second network node, wherein the channel state information report is based on measurement information corresponding to an FMCW-based reference signal.

20. The first network node of claim 19, wherein the at least one processor is further configured to:
communicate data with the second network node via the FSK-modulated FMCW communications based on the second set of parameters.

21-30. (canceled)
